(19) United States
(12) Patent Application Publication
(10) Pub. No.: US 2016/0149207 A1
(43) Pub. Date: May 26, 2016

(54) SURFACE TREATED SILICON CONTAINING ACTIVE MATERIALS FOR ELECTROCHEMICAL CELLS

(71) Applicant: Nexeon Limited, Abingdon (GB)

(72) Inventors: John Lahlouh, San Jose, CA (US); Klaus Joachim Dahl, Atherton, CA (US); Sarah Lynn Goertzen, Sunnyvale, CA (US); Marie Kerlau, Sunnyvale, CA (US); Jonathon David Speed, Reading (GB); Fiona Penelope Elaine Scott, Redhill (GB)

(73) Assignee: Nexeon Limited, Abingdon (GB)

(21) Appl. No.: 14/550,117

(22) Filed: Nov. 21, 2014

(51) Int. Cl. H01M 4/36; H01M 4/38; H01M 4/60

(52) U.S. Cl. CPC H01M 4/366; H01M 4/602; H01M 4/386

(57) ABSTRACT

Provided are active materials for electrochemical cells. The active materials include silicon containing structures and treatment layers covering at least some surface of these structures. The treatment layers may include aminosilane, a poly(amine), and a poly(imine). These layers are used to increase adhesion of the structures to polymer binders within active material layers of the electrode. As such, when the silicon containing structures change their size during cycling, the bonds between the binder and the silicon containing structure structures or, more specifically, the bonds between the binder and the treatment layer are retained and cycling characteristics of the electrochemical cells are preserved. Also provided are electrochemical cells and fabricated with such active materials, methods of fabricating these active materials and electrochemical cells and devices containing electrochemical cells fabricated with such active materials.

### BACKGROUND

Rapid development of mobile electronics, electrical vehicles, medical devices, and other like application demands high capacity rechargeable batteries that are light and small yet provide high storage capacity and electrical currents. Lithium ion technology presented some advancement in this area in comparison, for example, to lead-acid and nickel metal hydride batteries. However, to date, lithium ion cells are mainly built with graphite as a negative active material. Graphite's theoretical capacity is 372 mAh/g, and this fact inherently limits further improvement.

Silicon, germanium, tin, and many other materials are potential candidates for replacement of graphite because of their high lithiation capacities. For example, silicon has a theoretical capacity of about 4200 mAh/g, which corresponds to the Li4.4Si phase. Yet, adoption of these materials is limited in part by substantial changes in volume during cycling. For example, silicon expands by as much as 400% when charged to its theoretical capacity. Volume changes of this magnitude can cause stresses in the electrode, resulting in fractures and pulverization of active materials, losses of electrical and mechanical connections within the electrode, and capacity fading.

### SUMMARY

Provided are active materials for electrochemical cells. The active materials include silicon containing structures and treatment layers covering at least some surface of these structures. The treatment layers may include aminosilane, a poly(amine), and a poly(imine). These layers are used to increase adhesion of the structures to polymer binders within active material layers of the electrode. As such, when the silicon containing structures change their size during cycling, the bonds between the binder and the silicon containing structure structures or, more specifically, the bonds between the binder and the treatment layer are retained and cycling characteristics of the electrochemical cells are preserved. Also provided are electrochemical cells and fabricated with such active materials, methods of fabricating these active materials and electrochemical cells and devices containing electrochemical cells fabricated with such active materials.

In some embodiments, an active material for use in electrochemical cells includes a silicon containing structure and a treatment layer. The silicon containing structure includes an external surface. The treatment layer covers at least a portion of the external surface of the silicon containing structure. The treatment layer includes one or more of the following treatment materials: an aminosilane, a poly(amine), and a poly(imine). More specific examples of the treatment materials include aminopropyltriethoxysilane, aminopropylmethoxysilane, bis-gamma-trimethoxysilypropyl amine, aminoneohexyltrimethoxysilane, and aminoneohexylmethyldimethoxysilane. In some embodiments, a treatment material is one of poly(ethyleneimine), poly(allylamine), or poly(vinylamine). The silicon containing structure may have one of the following shapes: particles, pillared particles, porous particles, porous particle fragments, fibres, ribbons, flakes, and rods.

Provided is an active material for use in electrochemical cells, the active material comprising

a particulate material comprising:
a structure comprising silicon, the structure comprising an external surface;

a treatment layer covering at least a portion of the external surface of the structure comprising silicon and comprising an amine functional group;

wherein the treatment layer comprises one or more treatment materials selected from the group of formula (1):

J-(CH₂)ₘ—[[(CH₂)ₙK(CH₂)ₚ]_{q}—[O—Si(OR¹)₂₋ᵣ(R²)ᵣ—O-]ₛ]ₓ—(CH₂)ₜ—NHR³ (1)

wherein:

J is Si(OR⁴)_{2-w}(R⁵)_{w} or —NHR₆;

K is CHR₀ or NH;

M is an integer having a value of from 1 to 6;

n and p are each independently integers having a value of from 0 to 6;

q is an integer having a value from 0 to 30;

r is an integer having a value from 0 to 2;

s is an integer having a value from 0 to 9;

t is an integer having a value of from 1 to 6;

w is an integer having a value of from 0 to 2;

x is an integer having a value of from 0 to 15;

R⁰ is hydrogen, an amine, a C1-6 alkyl or an aminoalkyl group;

R¹ is a C1-6 alkyl group;

R² is a C1-6 alkyl or an aminoalkyl group;

R³ is a C1-6 alkyl group

R⁴ is a C1-6 alkyl group;

R⁵ is a C1-6 alkyl or an aminoalkyl group;

R⁶ is H or a C1-6 alkyl group.

Optionally the active material includes a treatment material of formula (1) in which

m is an integer having a value of from 1 to 3;

n is an integer having a value of from 0 to 3;

p is an integer having a value of from 0 to 3;

q is an integer having a value of from 0 to 15;

s is an integer having a value of from 0 to 6;

t is an integer having a value of from 1 to 3; and

x is an integer having a value of from 1 to 9.

Optionally the active material includes a poly(amine) as a treatment material, the poly(amine) having a structure selected from the group of formula (II)

NHR⁶—(CH₂)ₘ—[(CH₂)ₙCHR⁰(CH₂)ₚ]_{q}(CH₂)ₜ—NHR³ (II)

wherein

m is an integer having a value of from 1 to 6;

n is an integer having a value of from 0 to 3;

p is an integer having a value of from 0 to 3;

q is an integer having a value of from 0 to 12;

t is an integer having a value of from 1 to 6;

R⁰ is hydrogen, an amine group, a C₁₋₆ alkyl or a C₁₋₆ aminoalkyl group; and

R³ and R⁶ are each independently H or a C₁₋₆ alkyl group.

Optionally the active material includes a poly(imine) as a treatment material, the poly(amine) having a structure selected from the group of formula (III)

NHR⁶—(CH₂)ₘ—[(CH₂)ₙNH(CH₂)ₚ]_{q}(CH₂)ₜ—NHR³ (III)

wherein

m is an integer having a value of from 1 to 6;

n is an integer having a value of from 0 to 3;

p is an integer having a value of from 0 to 3;

q is an integer having a value of from 0 to 12;

t is an integer having a value of from 1 to 6;

R⁰ is hydrogen, an amine group, a C₁₋₆ alkyl or a C₁₋₆ aminoalkyl group; and

R³ and R⁶ are each independently H or a C₁₋₆ alkyl group.

Optionally when q=0, m+t≧2. Optionally when q=0, m+t≦12. Optionally the treatment material is selected from the group consisting poly(ethyleneimine), poly(allylamine), poly(vinylamine), 1,3-diaminopropane, 1,4-diaminobutane, 1,5-diaminopentane, diethylenetriamine, triethylenetetramine, tetraethylenepentamine and pentaethylenehexamine.

Optionally the treatment layer covers at least 40% of the external surface of the structure comprising silicon.

Optionally the treatment layer covers no more than 95% of the external surface of the structure.

Optionally the treatment material is a polyimine. Optionally the polyimine covers at least 40% of the external surface of the structure. Optionally the polyimine covers no more than 95% of the external surface of the structure.

Optionally the treatment material is an amino silane or an amine functionalised siloxane.

Optionally the amino silane or amine functionalised siloxane is a structure selected from the group of formula (IV)

Si(OR⁴)_{2-w}(R⁵)_{w}(CH₂)ₘ[[(CH₂)ₙK(CH₂)ₚ]_{q}[O—Si(OR¹)₂₋ᵣ(R²)ᵣ—O-]ₛ]ₓ—(CH₂)ₜ—NHR³

wherein:

K is CHR⁰ or NH;

m is an integer having a value of from 1 to 3;

n is an integer having a value of from 0 to 6;

p is an integer having a value of from 0 to 6;

q is an integer having a value of from 0 to 15;

r is an integer having a value from 0 to 2;

s is an integer having a value from 0 to 9;

t is an integer having a value of from 1 to 6;

w is an integer having a value of from 0 to 2;

x is an integer having a value of from 0 to 15;

R⁰ is hydrogen, an amine group, a C₁₋₆ alkyl or a C₁₋₆ aminoalkyl group;

R¹ is a C₁₋₆ alkyl group;

R² is a C₁₋₆ alkyl group;

R³ is H or a C₁₋₆ alkyl group

R⁴ is a C1-6 alkyl group; and

R⁵ is a C1-6 alkyl or an aminoalkyl group.

Optionally n and p are each integers independently having a value of from 0 to 3; q is an integer having a value of from 0 to 12; s is an integer having a value of from 0 to 6; t is an integer having a value of from 1 to 3; and x is an integer having a value of from 0 to 9. Preferably q has a value of from 0 to 6. Preferably s has a value of from 0 to 3. Optionally R⁰ is hydrogen or a C₁₋₆ aminoalkyl group, especially an amine terminated aminoalkyl group. R¹ is a C₁₋₃ alkyl group and R³ is preferably hydrogen. Optionally R⁴ is a C₁₋₃ alkyl group. Optionally R⁵ is a C₁₋₃ alkyl group.

Optionally the amino silane is selected from the group consisting aminopropyltriethoxysilane, aminopropylmethoxysilane, bis-gamma-trimethoxysilylpropyl amine; aminoneohexyltrimethoxysilane; aminoneohexylmethoxysilane; aminoundecyltriethoxysilane; amino-2-(dimethylethoxysilyl)propane; N-(2-aminoethyl)-3-aminopropyltriethoxysilane; N-(2-aminoethyl)-3-aminopropyltrimethoxysilane; and N-(2-aminoethyl)-3-aminopropylsilanol. Optionally the aminosilane or amine functionalised siloxane covers at least 40% of the external surface of the structure. Optionally the aminosilane or amine functionalised siloxane covers no more than 95% of the external surface of the structure.

Optionally the structures comprising silicon in the active material are one or more structures selected from the group consisting particles, pillared particles, porous particles, porous particle fragments, fibres, ribbons, rods and flakes.

Optionally the structure comprising silicon has a minimum dimension of at least 10 nm, preferably at least 20 nm, suitably 30 nm, especially 50 nm. Optionally the structures have a minimum dimension of at least 80 nm, preferably 100 nm, more preferably 200 nm. Optionally the structures have a minimum dimension of at least 1 μm.

Optionally the structures comprising silicon have a minimum dimension of no greater than 5 μm. Optionally the structures have a minimum dimension of no greater than 4 μm. Optionally the structures have a minimum dimension of no greater than 3 microns. Optionally the structures have a minimum dimension of no greater than 2.5 microns. Optionally the structures have a minimum dimension of no greater than 2 microns.

Optionally the structures comprising silicon have a maximum dimension of at least 1 μm, preferably at least 2 μm, more preferably at least 2.5 μm. Optionally the structures have a maximum dimension of at least 3 μm, preferably at least 3.5 μm. Optionally the structures have a maximum dimension of no greater than 50 μm, preferably no greater than 40 μm, especially no greater than 20 μm. Optionally the structures have a maximum dimension of no greater than 7 μm, preferably no greater than 6 μm, more preferably no greater than 5 μm, most preferably no greater than 4 μm.

Optionally the structures comprising silicon are characterised by an aspect ratio of (ratio of the minimum dimension to maximum dimension) of from 1:1 to 1000:1.

Optionally the structures are particles and are characterised by an aspect ratio of between 1:1 and 1:3, preferably 1:1. Optionally the particles are characterised by a D50 diameter of at least 1 μm, 2 μm, 2.5 μm, 3 μm, 3.5 μm. Optionally the particles are characterised by a D50 diameter of no greater than 40 μm, 30 μm, 20 μm, 10 μm, 7 μm, 6 μm, 5.5 μm, 5 μm, 4.5 μm, 4 μm. Optionally the particles are characterised by a BET surface area of at least 10 m2/g, preferably at least 15 m2/g, more preferably at least 20 m2/g, especially at least 50 m2/g. Optionally the particles are characterised by a BET surface area of no greater than 300 m2/g, preferably no greater than 250 m2/g, more preferably no greater than 100 m2/g, most preferably no greater than 150 m2/g, especially no greater than 120 m2/g.

Optionally the structures are pillared particles comprising a plurality of silicon pillars attached to and extending from a core. Optionally the pillared particles are characterised by an aspect ratio of from 1:1 to 3:1. Optionally the pillared particle is characterised by a D50 diameter of at least 1 μm, 2 μm, 2.5 μm, 3 μm, 3.5 μm. Optionally the pillared particles are characterised by a D50 of no greater than D50 diameter of no greater than 40 μm, 30 μm, 20 μm, 10 μm, 7 μm, 6 μm, 5.5 μm, 5 μm, 4.5 μm, 4 μm.

Optionally the pillars attached to and extending from a core of a pillared particle are characterised by a minimum dimension of at least 10 nm, preferably at least 20 nm, suitably 30 nm, especially 50 nm.

Optionally the pillars attached to and extending from the core of a pillared particle have a minimum dimension of no greater than 2 μm. Optionally the pillars attached to the core of a pillared particle have a maximum dimension (length) of at least 2 microns. Optionally the pillars attached to the core of a pillared particle have a maximum dimension of no greater than 200 microns, preferably no greater than 100 μm, more preferably no greater than 50 μm, especially no greater than 20 μm. Optionally the pillars attached to the core of a pillared particle are characterised by an aspect ratio (ratio of minimum dimension to maximum dimension) of from 1:2 to 1:200, preferably 1:2 to 1:100. Optionally the pillared particles are characterised by a BET surface area value of at least 10 m2/g, preferably at least 15 m2/g, more preferably at least 20 m2/g, especially at least 50 m2/g. Optionally the pillared particles are characterised by a BET surface area of no greater than 300 m2/g, preferably no greater than 250 m2/g, more preferably no greater than 100 m2/g, most preferably no greater than 150 m2/g, especially no greater than 120 m2/g.

Optionally the structures are porous particles. Optionally the porous particles comprise a plurality of pores or channels separated by wall structures, wherein the wall structures have a minimum dimension of at least 10 nm, preferably at least 20 μm, more preferably at least 30 μm, especially at least 50 μm. Optionally the wall structures of the porous particles have a minimum dimension of no greater than 2 μm, preferably no greater than 1 μm, more preferably no greater than 300 nm, most preferably no greater than 200 nm, especially no greater than 100 nm. Optionally the porous particles comprise pores or channels having a diameter of at least 50 nm, preferably at least 60 nm, more preferably at least 80 nm.

Optionally the porous particle comprises a pore having a diameter of no greater than 350 nm, preferably no greater than 300 nm, most preferably no greater than 250 nm, especially no greater than 200 nm, more especially no greater than 100 nm. Optionally the porous particle has a D50 diameter of at least 1 μm, 2 μm, 2.5 μm, 3 μm, 3.5 μm. Optionally the porous particle has a D50 diameter of no greater than 40 μm, 30 μm, 20 μm, 10 μm, 7 μm, 6 μm, 5.5 μm, 5 μm, 4.5 μm, 4 μm. Optionally the porous particle is characterised by a BET value if at least 10 m2/g, preferably at least 15 m2/g, more preferably at least 20 m2/g, especially at least 50 m2/g. Optionally the porous particle is characterised by a BET value of no more than 300 m2/g, preferably no greater than 250 m2/g, more preferably no greater than 100 m2/g, most preferably no greater than 150 m2/g, especially no greater than 120 m2/g. Optionally the porous particles are characterised by a ratio of the average dimension of the wall structures to the average D50 diameter of the porous particle of between 1:1000 to 1:20.

Optionally the structures comprising silicon are porous particle fragments. Optionally the porous particle fragments are characterised by a minimum dimension of at least 10 nm, preferably 15 nm, more preferably 20 nm, especially at least 30 nm and more especially at least 50 nm. Optionally the porous particle fragment comprises pores or channels and is characterised by a plurality of elongate elements separating and defining the pores or channels within the porous particle fragment, the elongate elements having a minimum dimension of at least 10 nm, preferably 15 nm, more preferably 20 nm, especially at least 30 nm and more especially at least 50 nm. Optionally a porous particle fragment is characterised by a coral-like structure. Optionally each porous particle fragment is devoid of pores or channels and is characterised by a deformed planar structure having a minimum dimension of at least 50 nm, preferably at least 100 nm, more preferably at least 500 nm. Optionally each porous particle fragment has a minimum dimension of no greater than 10 microns, preferably 5 microns, especially 2 microns. Optionally the porous particle fragments are characterised by a BET value of at least 10 m2/g, preferably at least 15 m2/g, more preferably at least 20 m2/g, especially at least 50 m2/g. Optionally the porous particle fragments are characterised by a BET value of no greater than 300 m2/g, preferably no greater than 250 m2/g, more preferably no greater than 100 m2/g, most preferably no greater than 150 m2/g, especially no greater than 120 m2/g. Optionally porous particles comprise an agglomeration of porous particle fragments.

Optionally the structures comprise silicon comprise fibres, each fibre characterised by a thickness (minimum dimension) and a length (maximum dimension). Optionally the fibres are characterised by a thickness of at least 10 nm, preferably at least 20 nm, more preferably at least 50 nm, preferably at least 100 nm. Optionally the fibres are characterised by a thickness of no greater than 5 microns, preferably no greater than 2 μm, more preferably no greater than 1 μm and especially no greater than 300 nm. Optionally the fibres are characterised by a length of at least 1 μm, preferably at least 5 μm. Optionally the fibres are characterised by a length of no greater than 200 microns, preferably no greater than 100 μm, more preferably no greater than 50 μm, especially no greater than 20 μm. Optionally the fibres are characterised by an aspect ratio (ratio of thickness to length) of at least 1:2. Optionally the fibres are characterised by an aspect ratio of no greater than 1:1000, preferably no greater than 1:200. Optionally the fibres are characterised by a BET value of at least 10 m2/g, preferably at least 15 m2/g, more preferably at least 20 m2/g, especially at least 50 m2/g. Optionally the fibres are characterised by a BET value of no greater than 300 m2/g, preferably no greater than 250 m2/g, more preferably no greater than 100 m2/g, most preferably no greater than 150 m2/g, especially no greater than 120 m2/g.

Optionally the structures comprising silicon are ribbons characterised by a thickness, a width and a length. Optionally the ribbons have a thickness of at least 10 nm, 20 nm, 50 nm, 100 nm, 200 nm. Optionally the ribbons have a thickness of no greater than 5 microns, preferably no greater than 2 μm, more preferably no greater than 1 μm and especially no greater than 300 nm. Optionally the ribbons have a width of at least 50 nm, 100 nm, 200 nm, 400 nm. Optionally the ribbons have a width of no greater than 10 microns, 5 μm, 4 μm, 2 μm, 1 μm. Optionally the ribbons have a length of at least 500 nm, 1 micron, 2 microns, 5 μm. Optionally the ribbons have a length of no greater than 200 microns, 100 microns, 50 microns. Optionally the ribbons are characterised by a BET value of at least 10 m2/g, preferably at least 15 m2/g, more preferably at least 20 m2/g, especially at least 50 m2/g. Optionally the ribbons are characterised by a BET value of no greater than 300 m2/g, preferably no greater than 250 m2/g, more preferably no greater than 100 m2/g, most preferably no greater than 150 m2/g, especially no greater than 120 m2/g.

Optionally the structures comprising silicon are flakes characterised by a thickness, a width and a length. Optionally the flakes have a thickness of at least 10 nm, 20 nm, 50 nm, 100 nm, 200 nm. Optionally the flakes have a thickness of no greater than 5 microns, 2 microns, 1 μm, 300 nm, 500 nm. Optionally the flakes have a width of at least 100 nm, 200 nm, 400 nm. Optionally the flakes have a width of no greater than 10 microns, 5 μm, 4 μm, 2 μm, 1 μm, 500 nm. Optionally the flakes have a length of at least 250 nm, 500 nm, 1 μm. Optionally the flakes have a length of no greater than 200 microns, 100 microns, 50 microns. Optionally the flakes are characterised by a BET value of at least 10 m2/g, preferably at least 15 m2/g, more preferably at least 20 m2/g, especially at least 50 m2/g. Optionally the flakes are characterised by a BET value of at least 300 m2/g, preferably no greater than 250 m2/g, more preferably no greater than 100 m2/g, most preferably no greater than 150 m2/g, especially no greater than 120 m2/g.

Optionally the particulate material comprises structures comprising at least 95 wt % elemental silicon. Optionally the particulate material comprises structures comprising at least 98 wt % elemental silicon. Optionally the particulate material comprises structures comprising at least 99.90 wt % elemental silicon. Optionally the particulate material comprises structures comprising no more than 99.99 wt % elemental silicon. Optionally the particulate material comprises structures comprising no more than 99.96 wt % elemental silicon. Optionally the particulate material comprises structures comprising no more than 99.6 wt % silicon.

Optionally the particulate material comprises structures comprising n-type silicon or p-type silicon. Optionally the structures comprising n-type silicon or p-type silicon comprise impurities selected from the group consisting boron, nitrogen, tin, phosphorous, aluminium and germanium and mixtures thereof. Optionally these impurities are present in an amount of no greater than 1% by weight of the silicon.

Optionally the particulate material comprises structures comprising an electroactive silicon alloy. Optionally the electroactive silicon alloy comprises, in addition to silicon, one or more elements selected from the group consisting aluminium, titanium, boron, phosphorous, germanium, tin, lead, nickel, cobalt, manganese, molybdenum, chromium, vanadium, copper, iron, tungsten, titanium, zinc, alkali metal and an alkali earth metal.

Optionally the particulate material comprises structures comprising an electroactive compound of silicon. Optionally the electroactive compound of silicon is a silicon oxide, a silicon carbide or a silicon nitride.

In some embodiments, the silicon containing structure includes a silicon alloy. The active material may also include a carbon containing layer covering at least a portion of the treatment layer. The carbon containing layer may include multiple carbon particles adsorbed or covalently bound to the treatment layer. In some embodiments, the external surface of the silicon containing structure includes silicon dioxide.

Optionally the structures comprising silicon comprise a coating layer disposed there over. Optionally the coating layer comprises carbon or silicon oxide.

Optionally the particulate material further comprises a coating layer disposed over the treatment layer. Optionally the coating layer comprises particulate carbon or pyrolytic carbon. Optionally the coating layer covers at least 40% of the surface of the particle. Optionally the coating layer comprises particulate carbon having a minimum dimension of at least 50 nm, preferably 100 nm. Optionally the coating layer comprises particulate carbon having a maximum dimension of no greater than 2 microns, preferably no greater than 1 micron, more preferably no greater than 200 nm, especially no greater than 100 nm.

Optionally the particulate material is characterised by a D50 value of at least 1 μm, preferably at least 2 μm, more preferably at least 3 μm, especially at least 5 μm. Optionally the particulate material is characterised by a D50 value of no greater than 40 μm, preferably no greater than 30 μm, especially no greater than 15 μm. Optionally the particulate material is characterised by a BET value of at least 10 m2/g, preferably at least 15 m2/g, more preferably at least 20 m2/g, especially at least 50 m2/g. Optionally the particulate material is characterised by a BET value of no greater than 300 m2/g, preferably no greater than 250 m2/g, more preferably no greater than 100 m2/g, most preferably no greater than 150 m2/g, especially no greater than 120 m2/g.

In some embodiments, the volume ratio of the treatment layer to the silicon containing structure is between about 0.001% and 10%. More specifically, the volume ratio of the treatment layer to the silicon containing structure is less than about 0.1%. In some embodiments, the treatment layer is formed by molecules of the one or more treatment materials adsorbed on the external surface of the silicon containing structure. The treatment layer may be also formed by molecules of the one or more treatment materials covalently bound to the external surface of the silicon containing structure. In some embodiments, the treatment material includes aminosilane. The one or more treatment materials may form oligomeric brushes extending away from the external surface of the silicon containing structure.

Optionally the active material comprises 5 to 100 wt % of the particulate material based on the dry weight of the active material. The active material may form part of a composite material for use in an electrochemical cell; such composite materials comprise an active material and a polymeric binder and/or provides a composite material for use in an electrochemical cell. Optionally the composite material comprises at least 5 wt % of a polymeric binder based on the dry weight of the composite material.

Optionally the polymeric binder is selected from the group consisting polyacrylic acid, polysulphonic acid, polyalkylanhydride, carboxymethylcellulose, styrene butadiene rubber, polyalkylacid halides, polyalkylsulphonyl cholorides, polyvinylenedifluoride and derivatives and salts thereof. Optionally the polymer binder has a number average molecular weight in the range 50,000 to 1,000,000, preferably 100,000 to 500,000. Optionally the polymer binder is a polyacrylic acid having a molecular weight in the range 150,000 to 450,000. Optionally the polymer binder is a functionalised polyvinylenedifluoroide having a molecular weight in the range 150,000 to 450,000. Optionally the polymer binder is a linear polymer binder.

Optionally the composite material comprises 5 to 95 wt % of the particulate material and at least 5 wt % of a polymeric binder based on the dry weight of the active material. Optionally the composite material comprises a particulate material, a polymeric binder and one or more species selected from graphite and a conductive carbon. Optionally the composite material comprises 5 to 80 wt % of a particulate material, 5 to 15 wt % of a polymeric binder, 0 to 15% of graphite and 0 to 10 wt % of a conductive carbon. Optionally the graphite in the composite is selected from a synthetic or natural graphite having a crystallite length of greater than 50 nm, preferably greater than 100 nm. Optionally the graphite in the composite material has a D50 diameter in the range 10 to 50 μm, preferably 10 to 40 μm, more preferably 10 to 30 μm and especially 10 to 25 μm. Optionally the graphite in the composite material is selected from Timrex®, SFG6®, SFG10®, SFG15®, KS4® and KS6®. Optionally the graphite is provided in the form of mesocarbon microbeads having a particle size of greater than 10 μm, a density of greater than 1.15 and a surface area of less than 3 m2/g. Hard and soft carbon materials can also be used.

Optionally the conductive carbon in the active material is selected from one or more of the group comprising carbon black, ketjen black, lamp black, carbon nanotubes and vapour grown carbon fibres. Optionally the conductive carbon in the active material has at least one dimension less than 1 μm, preferably less than 500 nm especially less than 200 nm.

Optionally the polymeric binder of the active material is covalently bound to the treatment material of the particulate material, the treatment material being disposed on the surface of the silicon structure.

Also provided is a method of fabricating an active material for use in an electrochemical cell. The method may involve preparing a solution that includes a carrier solvent and one or more of the treatment materials. Optionally the solution may contain the following treatment materials: an aminosilane coupling agent, a poly(amine), and a poly(imine). The method may proceed with combining the solution with silicon containing structures. The acidity of the solution is maintained at between about 4.0 pH and 6.0 pH for the amino-silanization. The method may proceed with removing the carrier solvent while retaining the one or more treatment materials on external surfaces of the silicon containing structures. Removing of the carrier solvent may be performed at a temperature of between about 40° C. and 80° C. In some embodiments, the method also involves performing a heat treatment on the silicon containing structures and the one or more treatment materials. The heat treatment adoptively or covalently anchors the one or more treatment materials to the external surfaces of the silicon containing structures. The heat treatment may be performed at a temperature of between about 80° C. and 130° C. In some embodiments, the method may also involve combining the solution with carbon containing structures such that the carbon containing structures form a layer over the silicon containing structures.

The method may include the steps of:
a. Providing a solution of the treatment material in a carrier solvent;
b. Combining the solution of step (a) with structures comprising silicon to form a slurry;
c. Adjusting the pH of the slurry to a value of between pH 3 and pH6 and mixing the slurry, thereby to facilitate the formation of a treatment layer over at least a portion of the structure comprising silicon.

The carrier solvent can be water or a mixture of alcohol and water. Mixtures of alcohol and water in the ratio 1:10 to 10:1 may be used.

The amount of treatment material used will depend on the surface area of the silicon particles being treated. Suitably between 0.1 and 1 m1 of treatment agent is used per 100 g of silicon particles having a surface area of 2.65 m2/g.

Optionally the step of mixing the slurry at a pH of between pH3 and pH6 is carried out at a temperature of between 10° C. and 60° C.

The slurry is suitably mixed at a pH of between 4 and 5.

Optionally, the method further comprises the step of removing the carrier solvent. Optionally the carrier solvent is removed at a temperature in the range 40 to 100° C.

Optionally the method further comprises the step of heat treating the treated structures comprising silicon thereby to anchor the treatment material to the surface of the silicon. Optionally the heat treatment step is carried out at a temperature of between 80° C. and 140° C., preferably between 80° C. and 130° C.

Optionally the method further comprises the step of providing a coating over the surface of the treatment layer. Optionally the coating covers no more than 90% of the surface of the particle. Optionally the coating comprises particulate carbon or pyrolytic carbon. Optionally the coating comprises a particulate carbon having a D50 diameter of less than 2 microns, preferably less than 1 micron, especially less than 0.2 microns. Examples of particulate carbon that can be used to coat the treated silicon particles include carbon black, ketjen black, lamp black, carbon nanotubes and vapour grown carbon fibres.

The composite materials can be readily prepared by extending the method steps described herein. Also provided are methods of preparing a composite material. In some embodiments the method involves the steps of:
a. forming a particulate material comprising a structure comprising silicon having an external surface and a treatment layer covering at least a portion of the external surface;
b. Forming a solution of the polymer binder in a carrier solvent; and
c. Combining the solution of the polymer binder with the particulate material of (a) to form a slurry and drying the slurry to form the active material.

The solution of a polymer binder can be a solution in a solvent comprising water or a mixture of alcohol and water. Mixtures of alcohol and water in the ratio 1:10 to 10:1 may be used.

Optionally the method further comprises the step of combining the slurry formed in step (c) with one or more species selected from a graphite as defined herein above and a conductive carbon as defined herein above.

Optionally the method further comprises the step of heat treating the active material obtained from drying the slurry. Optionally the heat treatment causes the linear polymer to bond to the layer of the treatment material on the external surface of the silicon particles. Optionally the heat treatment is carried out at a temperature of from 80 to 180° C.

Optionally the solution of the polymer binder in the carrier solvent comprises no more than 20 wt % of the polymer. Preferably the solution of the polymer binder comprises 0.1 to 10 wt % of polymer, more preferably 0.1 to 2 wt %.

Optionally the slurry formed by combining the solution of the polymer binder with the particulate material comprises at least 0.001 Kg (silicon particles)/Kg (carrier solvent) silicon particulate material, preferably at least 0.003 Kg/Kg and especially 0.005 kg/Kg. Optionally the slurry formed comprises no more than 0.03 kg/kg silicon particulate material. Optionally the slurry formed comprises at least 150 m2 (particulate surface)/l, preferably at least 200 m2/g and especially 265 m2/g.

Also provided is an electrode comprising an active material and a current collector. Also provided is a method of fabricating an electrode for use in electrochemical cells. The method involves forming a slurry including an active material and a binder casting the slurry onto a current collector and drying the slurry. The method may comprise the further step of heat treating the electrode after the slurry is dried or as part of the drying process. The active material includes silicon containing structure individually covered with a layer of a treatment material. Preferred treatment materials include one or more of the following materials: an aminosilane, a poly(amine), and a poly(imine). The binder may include poly acrylic acid (PAA). The method may proceed with coating the slurry onto a substrate and drying the slurry.

Also provided is an electrochemical cell comprising an active material. Also provided is a device comprising an active material.

These and other embodiments are described further below with reference to the figures.

### BRIEF DESCRIPTION OF THE DRAWINGS

FIG. 1A is a schematic illustration of an electrode prior to first charging, in accordance with some embodiments.

FIG. 1B is a schematic illustration of the electrode in FIG. 1A after the initial charging, in accordance with some embodiments.

FIG. 1C is a schematic illustration of the electrode in FIGS. 1A and 1B after discharging showing voids within an active material layer caused by contracting of the active material particles, in accordance with some embodiments.

FIG. 2 is a process flowchart of a method for treating active material structures to enhance their bonding characteristics, in accordance with some embodiments.

FIG. 3A illustrates a treated active material structure that has portions of its surface covered with a treatment agent, in accordance with some embodiments.

FIG. 3B illustrates a treated active material structure that has its entire surface covered with a treatment agent, in accordance with some embodiments.

FIG. 3C illustrates a treated active material agglomerate that includes two active material structures enclosed into a shared shell formed by a treatment agent, in accordance with some embodiments.

FIG. 4 is a process flowchart corresponding to a method of forming an electrode using treated active material structures, in accordance with some embodiments.

FIG. 5 illustrates a schematic cross-section view of the wound cylindrical cell, in accordance with some embodiments.

FIG. 6A illustrates a cycling data plot for two cells fabricated using different negative active materials.

FIG. 6B illustrates a cycling data plot for three cells fabricated using different negative active materials.

FIG. 7 illustrates a subtractively normalized FTIR spectrum generated for electrode materials comprising Silquest treated silicon particles (sample) and for electrode materials comprising untreated silicon particles (control) over a range of voltage values extending from 10 mV to 2500 mV.

FIG. 8 illustrates a basic FTIR spectrum carried out on samples comprising either untreated silicon particles or Silquest treated silicon particles, illustrating the structural differences in structure between the sample and the control.

FIG. 9 illustrates the equivalent circuit used to model the silicon components, lithium components and resistance arising from the internal resistance of the cell for the purpose of Electrochemical Impedance spectroscopy (EIS).

FIG. 10 illustrates how the reduction potentials vary over the number of charging and discharging cycles for electrode materials comprising either Silquest™ treated silicon particles as described herein or untreated silicon particles (control).

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

The capacity of a lithium ion battery can be substantially increased by partial or complete replacement of carbon-based active materials with silicon based materials and/or other similar high capacity materials, such as tin and germanium. However, integration of these high capacity materials into battery electrode has proved to be challenging because of volume changes that these materials experience during lithiation. Previous integration approaches focused on reducing the size of silicon containing structures and combining these structures with other materials to reduce volume change effects. However, these approaches led to low capacity designs and inefficient use of silicon. Similar approaches haven been tried with other high capacity material.

This volume change during lithiation also causes significant challenges in selecting a binder, which can be effectively used with such dynamic active materials. A binder is used to hold active material structures together in an electrode layer and attached to a substrate. Polyvinylidene fluoride (PVDF) is the most common binder for lithium ion cells. When combined with silicon structures, PVDF molecules and the silicon structures are bound by weak van der Waals forces and fail to accommodate large volume changes of the structures. As such, PVDF shows poor performance in holding the silicon structures together and maintaining mechanical and electrical connections between the structures, which results in capacity fading. Likewise, binders that have only hydroxyl functional groups or carbonyl functional groups, such as polyvinyl alcohol (PVA) and polyacrylamide (PAM), do not exhibit enough binding strength to silicon particles when the silicon particles expand and contract during cycling. The problem is particularly acute for electrode materials comprising silicon particles having a diameter of greater than 8 μm; stresses established within these particles during the lithiation and de-lithiation result in the fragmentation of the particles, which rapidly become electrically disconnected from the electrode material of which they form a part if they are only weakly bound by the binder.

There is therefore a need for an electroactive silicon particulate material that is able to remain electrically connected to an electrode material of which it forms a part. There is also a need for an electroactive silicon particulate material that is able to remain electrically connected to an electrode material of which it forms a part without significantly fragmenting. There is also a need for an electroactive silicon particulate material that is able to remain electrically connected to an electrode material of which it forms a part and which is characterized by a surface layer, which facilitates the efficient transport of lithium ions into and away from the particle. The present disclosure addresses these needs.

Provided is an active material for use in electrochemical cells, the active material comprising a particulate material comprising:
a. a structure comprising silicon, the structure comprising an external surface;
b. a treatment layer covering at least a portion of the external surface of the structure comprising silicon and comprising an amine functional group;

wherein the treatment layer comprises one or more treatment materials selected from the group of formula (1):

J-(CH₂)ₘ—[[(CH₂)ₙK(CH₂)ₚ]_{q}—[O—Si(OR¹)₂₋ᵣ(R²)ᵣ—O-]ₛ]ₓ—(CH₂)ₜ—NHR³ (1)

wherein:

J is Si(OR⁴)_{2-w}(R⁵)_{w} or —NHR⁶;

K is CHR⁰ or NH;

M is an integer having a value of from 1 to 6;

n and p are each independently integers having a value of from 0 to 6;

q is an integer having a value from 0 to 30;

r is an integer having a value from 0 to 2;

s is an integer having a value from 0 to 9;

t is an integer having a value of from 1 to 6;

w is an integer having a value of from 0 to 2;

x is an integer having a value of from 0 to 15;

R⁰ is hydrogen, an amine, a C₁₋₆ alkyl or an aminoalkyl group;

R¹ is a C₁₋₆ alkyl group;

R² is a C₁₋₆ alkyl or an aminoalkyl group;

R³ is a C₁₋₆ alkyl group

R⁴ is a C₁₋₆ alkyl group;

R⁵ is a C₁₋₆ alkyl or an aminoalkyl group;

R⁶ is H or a C₁₋₆ alkyl group.

The active material may include a treatment material of formula (1) in which

m is an integer having a value of from 1 to 3;

n is an integer having a value of from 0 to 3;

p is an integer having a value of from 0 to 3;

q is an integer having a value of from 0 to 15;

s is an integer having a value of from 0 to 6;

t is an integer having a value of from 1 to 3; and

x is an integer having a value of from 1 to 9.

It has been found that certain surface treatments of silicon containing structures can significantly improve performance of lithium ion cells when used with certain binders. Specifically, silicon containing structures can be treated with various aminosilanes, amino functionalized siloxanes, poly(amines), and/or poly(imines) to modify the surface of the structures and to improve adhesion of these structures to the specific binders. Specific examples of suitable treating agents include, but not limited to, aminopropyltriethoxysilane, aminopropylmethoxysilane, bis-gamma-trimethoxysilylpropyl amine; aminoneohexyltrimethoxysilane; aminoneohexylmethoxysilane; aminoundecyltriethoxysilane; amino-2-(dimethylethoxysilyl)propane; N-(2-aminoethyl)-3-aminopropyltriethoxysilane; N-(2-aminoethyl)-3-aminopropyltrimethoxysilane; and N-(2-aminoethyl)-3-aminopropylsilanol, poly(amine) is selected from the group consisting poly(ethyleneimine), poly(allylamine), poly(vinylamine), 1,3-diaminopropane, 1,4-diaminobutane, 1,5-diaminopentane, diethylenetriamine, triethylenetetramine, tetraethylenepentamine and pentaethylenehexamine. For example, Silquest® Y-15744, which is an amino-functional organoalkoxysiloxane (available from Momentive Performance Materials Inc. in Columbus, Ohio), may be used for this purpose. The treatment layer suitably covers at least 40% of the external surface of the structures comprising silicon. Preferably the treatment layer covers no more than 95% of the structures comprising silicon.

Treated silicon structures of the type described herein are characterized by improved bonding to the polymer binders used in the manufacture of electrodes and the electrode materials (including treated silicon particles disclosed herein) are characterized by greater cohesion than control samples including untreated silicon particles. The presence of the aminosilane coating at the surface of the silicon particles also seems to improve the nature of the SEI layer generated at the silicon surface during the charging and discharging cycles of the electrode material including the treated particles.

The treatment material may be a polyamine selected from the group of formula (II):

NHR⁶—(CH₂)ₘ—[(CH₂)ₙCHR⁰(CH₂)ₚ]_{q}(CH₂)ₜ—NHR³ (II)

wherein

m is an integer having a value of from 1 to 6;

n is an integer having a value of from 0 to 3;

p is an integer having a value of from 0 to 3;

q is an integer having a value of from 0 to 12;

t is an integer having a value of from 1 to 6;

R⁰ is hydrogen, an amine group, a C₁₋₆ alkyl or a C₁₋₆ aminoalkyl group; and

R³ and R⁶ are each independently H or a C₁₋₆ alkyl group.

Also provided is a polyimine material having a structure of formula (III):

Suitable examples of poly(amine)s of formula (II) include poly(ethyleneimine), poly(allylamine), poly(vinylamine), 1,3-diaminopropane, 1,4-diaminobutane, 1,5-diaminopentane, diethylenetriamine, triethylenetetramine, tetraethylenepentamine and pentaethylenehexamine.

The polyamine treatment layer suitably covers at least 40% of the external surface of the structures comprising silicon. Suitably the polyamine treatment layer covers no more than 95% of the external surface of the structures comprising silicon.

The treatment material may be an aminosilane or amine functionalised siloxane. Suitably the aminosilane or amine functionalised siloxane species has a structure of formula (IV):

Si(OR⁴)_{2-w}(R⁵)_{w}[[(CH₂)ₙCHR⁰(CH²)ₚ]_{q}—[O—Si(OR¹)₂₋ᵣ(R²)ᵣ—O-]ₛ]ₓ—(CH₂)ₜ—NHR³

wherein:

n is an integer having a value of from 0 to 6;

p is an integer having a value of from 0 to 6;

q is an integer having a value of from 0 to 15;

r is an integer having a value from 0 to 2;

s is an integer having a value from 0 to 9;

t is an integer having a value of from 1 to 6;

w is an integer having a value of from 0 to 2;

x is an integer having a value of from 0 to 15;

R⁰ is hydrogen, an amine group, a C₁₋₆ alkyl or a C₁₋₆ aminoalkyl group;

R¹ and R² are independently C₁₋₆ alkyl groups;

R³ is H or a C₁₋₆ alkyl group

R⁴ is a C₁₋₆ alkyl group; and

R⁵ is a C₁₋₆ alkyl or an aminoalkyl group.

In some embodiments, a treatment layer is represented by formula (III) in which:

n and p are independently integers having a value of from 0 to 3;

q is an integer having a value of from 0 to 12, preferably 0 to 6;

r is an integer having a value of from 0 to 2;

s is an integer having a value of from 0 to 9, preferably 0 to 3;

t is an integer having a value of from 1 to 6, preferably 1 to 3;

w is an integer having a value of from 0 to 2;

x is an integer having a value of from 0 to 9;

R¹, R², R⁴ and R⁵ are each independently C₁₋₃ alkyl groups;

R³ is hydrogen.

Also provided is a structure of formula (III) in which:

n and p are independently integers having a value of from 0 to 3;

q is an integer having a value of from 0 to 6;

r is an integer having a value of from 0 to 2;

s is 0;

t is an integer having a value of from 1 to 3;

w is an integer having a value of from 0 to 2;

x is an integer having a value of from 0 to 9;

R¹, R², R⁴ and R⁵ are each independently C₁₋₃ alkyl groups;

R³ is hydrogen.

Also provided is a structure of formula (III) in which:

NHR⁶—(CH₂)ₘ—[(CH₂)ₙCHR⁰(CH₂)ₚ]_{q}(CH₂)ₜ—NHR³

n and p are independently integers having a value of from 0 to 3;

q is 0;

r is an integer having a value of from 0 to 2;

s is an integer having a value of from 1 to 4;

t is an integer having a value of from 1 to 3;

w is an integer having a value of from 0 to 2;

x is an integer having a value of from 1 to 3;

R¹, R², R⁴ and R⁵ are each independently C₁₋₃ alkyl groups;

R³ is hydrogen.

Examples of suitable aminosilanes include aminopropyltriethoxysilane, aminopropylmethoxysilane, bis-gamma-trimethoxysilylpropyl amine; aminoneohexyltrimethoxysilane; aminoneohexylmethoxysilane; aminoundecyltriethoxysilane; amino-2-(dimethylethoxysilyl)propane; N-(2-aminoethyl)-3-aminopropyltriethoxysilane; N-(2-aminoethyl)-3-aminopropyltrimethoxysilane; and N-(2-aminoethyl)-3-aminopropylsilanol.

Treatment materials of formula (III) suitably cover at least 40% of the external surface of the structures comprising silicon. Suitably these treatment materials cover no more than 95% of the external surface of the structures comprising silicon.

Without being restricted to any particular theory, it is believed that when silicon structures are exposed to air, the structures form a surface layer of silicon dioxide. Similar surface oxidation is experienced by other high capacity active materials, such as germanium and tin. The surface oxidation may occur during handling and processing of these structures, for example, while fabricating electrode for lithium ion batteries. From the conventional standpoint, the surface oxidation may be undesirable because silicon dioxide has a much higher resistivity (1016 Ω*m) than silicon (103 Ω*m).

When the silicon dioxide surface is exposed to water (e.g., in a water based solution of a binder), the surface ionizes and assumes a negative zeta potential, which may be up to −70 mV in some embodiments. A similar phenomenon has been observed with germanium particles and tin. Furthermore, silicon, tin, and/or germanium may be a part of an alloy that includes other components and undergo the same oxidation and surface ionization process as described above. For example, silicon may be alloyed with tin. In general, if oxides of alloying elements are amphoteric, the zeta potential at pH>6 is negative.

Many polymer binders used to support active materials on the substrate, such as polyvinylidene difluoride (PVDF), carboxymethyl cellulose (CMC), styrene butadiene (SBR), alginates, poly acrylic acid (PAA), poly sulphonic acid and poly maleic acid may produce negatively charged groups when exposed to solvents. For examples, when PAA dissociates in water at pH>4, it produces negatively charged carboxylate groups along the polymer chains. Similar effects occur with poly maleic acid and poly sulphonic acid binder species. At lower pH levels, many of the PAA chains of a polyacrylic acid binder are protonated. While these negative charged groups may be used to increase hydrogen in some embodiments, the acidic PAA chains are coiled resulting in a high viscosity of the mixture, often too excessive for adequate processing. At pH level greater than about 9, the PAA chains are elongated to the point where the mixture has too high of a viscosity to permit coating. A solution having a pH of between about 3 and 7 or, more specifically, of between about 4 and 6, such as about 6 may yield an appropriate viscosity for coating. Without being restricted to any particular theory it is believed that adjusting the pH of the PAA binder solution from the levels listed above, e.g., by adding NaOH, increases the viscosity and thereby optimizes the rheology of the casting formulation to permit facile processing Overall, the binder resin may serve several functions. The binder may have high fracture resistance strength and form strong interfacial bonds to the particles of the electrode layer, such as active material particles and/or conductive additive particles. The binder may prevent fracturing within the electrode layer and overcome stresses developed within the layer during charging and discharging. This fracture prevention helps to maintain electronic conduction throughout the layer and between the layer and the current collector. The fracture resistance strength may be enhanced by treating the active material particles. Furthermore, a binder should also allow lithium ion transport through an electrode layer. This ion transport is sometimes referred to as shuttling and occurs between the electrolyte solution and the active material particles of the electrode layer. The ion transport may be facilitated by binders that have carboxylic acid groups. Further, binders capable of dissolving in water, i.e., water-soluble binders are generally preferable because of their lesser environmental impact, simpler processing, and lower cost.

In a typical mixture used to form an electrode layer, negatively charged structures and negatively charged binder molecules repel each other (while in the solution and then in the electrode) resulting in weak interfacial bond strength and fracturing. Specifically, weak bonds between the active material structures and binder molecules result in the active material structures dis-bonding from the binder molecules and losing electrical connections within the electrode and capacity fading during the lifetime of a cell including the mixture. The loss of electrical connections and capacity fading is particularly prominent in electrochemical cells fabricated with high capacity active materials that are susceptible to large volume changes, such as silicon. Furthermore, it should be noted that most carbon-based active materials (or conductive additives) also have a negative zeta potential when dispersed in water.

Surface modification of the active material structures with treatment materials, which comprise moieties containing amino groups is believed to impart a positive zeta potential to the structures. In general, various materials, such as aminosilanes or other organic molecules containing primary amines (NH2) and/or secondary amines (NH) or imines can be used. These materials are found to be effective surface modifiers as long as the surface modifying moieties can either be anchored to or adsorbed on the surface of the structure being modified. In some embodiments, anchoring may be achieved by forming chemical bonds. For example, aminosilane treatment materials form ester bonds to active material particles and amide bonds with some polymeric binders, while poly(electrolyte) species such as a polyamine and a polyimine adsorb on the surface of the particles. Tertiary amines, such as poly(diallyldimethylammonium chloride), do not form amide bonds but can provide stabilization of particle dispersions. In some embodiments, the modified structures include the amino groups and exhibit the positive zeta potential unlike unmodified structures that may exhibit the negative zeta potential. As such, the modified structures would more readily associate with the negatively charged binder molecules and may even form amide bond between active particles and binder molecules.

Without being restricted to any particular theory, it is believed that moieties with amino groups can be attached to silicon dioxides and other types of surfaces in a number of ways. One attachment type is adsorption of cationic poly (electrolytes), such as poly(ethyleneimine) or poly(allylamine). The poly(electrolyte) may form one or more mono molecular layers on the surfaces of the active material particles. The poly(electrolytes) may be used to treat silicon containing structures and carbon containing structures. Adsorption may be caused by van der Waals (dispersion) forces, hydrogen bonding, and ionic (electrostatic) bonding.

Furthermore, sequential layer-by-layer deposition of poly(cations) and poly(anions) may be used to form a multilayered poly(electrolyte salt) structure on the surface of the active material particles. The outermost layer of this multilayered structure may be dominated by the functional groups of the last poly(electrolyte) adsorbed. Without being restricted to any particular theory, it is believed that multilayers provide a more robust surface modification of the active material particles.

Another attachment type is covalent bonding. For example, aminosilanes are believed to form covalent bonds with the silicon dioxide shell of silicon particles. One molecule of aminosilane can covalently bond to 1 or 2 SiOH groups of that shell. Under certain reaction conditions, the aminosilane forms oligomeric brushes extending away from the silicon dioxide shell. These brushes may contain several amino groups.

When large molecules, such as polymers, are used for treatment of the silicon structures, the same molecule may form multiple bonding sites on the surface of the silicon structure of an active material particle. The bonding sites may extend along the polymer chain and, in some embodiments, provide a mono-molecular layer. The number of bonding sites and the strength of attachment may increase with the molecular weight of a polymer.

The nature of the structures comprising silicon in the active material has also been found to strongly influence the performance of cells including the active material. In some embodiments, the active material comprises silicon structures selected from the group consisting particles, pillared particles, porous particles, porous particle fragments, fibres, ribbons and flakes.

The structures can suitably be defined by a minimum dimension, a maximum dimension or a D50 diameter. The structure suitably has a minimum dimension of at least 10 nm, preferably at least 20 nm, suitably 30 nm, especially 50 nm. The structures preferably have a minimum dimension of at least 80 nm, preferably 100 nm, more preferably 200 nm. Most preferably the structures have a minimum dimension of at least 1 μm.

For the avoidance of doubt the term “minimum dimension” refers to the smallest diameter of a smallest element within a structure. For example pillared particles contain pillars, which themselves have a smallest dimension which is less than the diameter of the particle itself. Smallest dimensions can be measured using microscopy techniques such as SEM and TEM.

The structures suitably have a minimum dimension of no greater than 5 μm. Preferably the structures have a minimum dimension of no greater than 4 μm. More preferably the structures have a minimum dimension of no greater than 3 microns. Most preferably the structures have a minimum dimension of no greater than 2.5 microns. It is especially preferred that the structures have a minimum dimension of no greater than 2 microns.

The structures preferably have a maximum dimension of at least 1 μm, preferably at least 2 μm, more preferably at least 2.5 μm. Suitably the structures have a maximum dimension of at least 3 μm, preferably at least 3.5 μm. Preferably the structures have a maximum dimension of no greater than 50 μm, more preferably no greater than 40 μm, especially no greater than 20 μm. It is especially preferred that the structures have a maximum dimension of no greater than 7 μm, preferably no greater than 6 μm, more preferably no greater than 5 μm, most preferably no greater than 4 μm, especially no greater than 3.5 μm.

The structures comprising silicon are suitably characterised by an aspect ratio of (ratio of the minimum dimension to maximum dimension) of from 1:1 to 1000:1.

Where the first high capacity active material is provided in the form of particles, pillared particles, porous particles or porous particle fragments, these particles suitably have a D50 diameter of at least 1 μm, preferably at least 2 μm, more preferably at least 2.5 μm, 3 μm, 3.5 μm, more preferably at least 5 μm. The active material particles suitably have a diameter of no more than 40 μm, preferably no more than 30 μm, more preferably no more than 25 μm, for example no more than 10 μm, preferably 7 μm, 6 μm, 5.5 μm, 5 μm, 4.5 μm or 4 μm. Porous particles may be formed from fragments having a D50 diameter of less than 300 nm, preferably less than 200 nm, for example 50 to 100 nm.

In one preferred embodiment the particles have a D50 diameter in the range 1 to 7 μm. Optionally the D50 particle diameter may be at least 1.5 μm, at least 2 μm, at least 2.5 μm or at least 3 μm. Optionally the D50 particle diameter may be no more than 6 μm, no more than 5 μm, no more than 4.5 μm, no more than 4 μm, or no more than 3.5 μm. It has been found that particles within this size range are ideally suited for use in hybrid anodes for metal-ion batteries, due to their dispersibility in slurries, their ability to occupy void space between conventional synthetic graphite particles in anode layers, their structural robustness and their resilience to repeated charge-discharge cycles.

In a second embodiment the high capacity active material comprises particles having a D50 diameter in the range 10 to 15 μm.

In a third embodiment the particles have a D50 diameter in the range 20 to 25 μm.

Preferably, the particles have a narrow size distribution span. For instance, the particle size distribution span (defined as (D90-D10)/D50) is preferably 5 or less, more preferably 4 or less, more preferably 3 or less, more preferably 2 or less, and most preferably 1.5 or less. For the avoidance of doubt, the term “particle diameter” as used herein refers to the equivalent spherical diameter (esd), i.e. the diameter of a sphere having the same volume as a given particle, wherein the particle volume is understood to include the volume of the intra-particle pores. The terms “D50” and “D50 particle diameter” as used herein refer to the volume-based median particle diameter, i.e. the diameter below which 50% by volume of the particle population is found. The terms “D10” and “D10 particle diameter” as used herein refer to the 10th percentile volume-based median particle diameter, i.e. the diameter below which 10% by volume of the particle population is found. The terms “D90” and “D90 particle diameter” as used herein refer to the 90th percentile volume-based median particle diameter, i.e. the diameter below which 90% by volume of the particle population is found. The terms “D99” and “D99 particle diameter” as used herein refer to the 99th percentile volume-based median particle diameter, i.e. the diameter below which 99% by volume of the particle population is found.

Particle diameters and particle size distributions can be determined by routine laser diffraction techniques. Laser diffraction relies on the principle that a particle will scatter light at an angle that varies depending on the size the particle and a collection of particles will produce a pattern of scattered light defined by intensity and angle that can be correlated to a particle size distribution. A number of laser diffraction instruments are commercially available for the rapid and reliable determination of particle size distributions. Unless stated otherwise, particle size distribution measurements as specified or reported herein are as measured by the conventional Malvern Mastersizer 2000 particle size analyzer from Malvern Instruments. The Malvern Mastersizer 2000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle size distribution. Laser diffraction values as reported herein are obtained using a wet dispersion of the particles in distilled water. The particle refractive index is taken to be 3.50 and the dispersant index is taken to be 1.330. Particle size distributions are calculated using the Mie scattering model.

By the term porous shall be understood as referring to a high capacity electroactive particle comprising a plurality of pores, voids or channels within a particle structure. The term “porous particle” shall be understood in particular to include particles comprising a random or ordered network of linear, branched or layered elongate structural elements, wherein interconnected void spaces or channels are defined between the elongate structural elements of the network, the elongate structural elements suitably including linear, branched or layered fibres, tubes, wires, pillars, rods, ribbons, plates or flakes. Preferably the porous particles have a substantially open porous structure such that substantially all of the pore volume of the porous particles is accessible to a fluid from the exterior of the particle, for instance to a gas or to an electrolyte. By a substantially open porous structure, it is meant that at least 90%, preferably at least 95%, preferably at least 98%, preferably at least 99% of the pore volume of the porous particles is accessible from the exterior of the particles. The intra-particle porosity of the porous particles should be distinguished from the inter-particle porosity of the high capacity electroactive porous particles. Intra-particle porosity is defined by the ratio of the volume of pores within a particle to the total volume of the particle. Inter-particle porosity is the volume of pores between discrete particles and is a function both of the size and shape of the individual particles and of the packing density of the particulate material. The total porosity of the particulate material may be defined as the sum of the intra-particle and inter-particle porosity.

The intra-particle porosity of the porous particles is preferably at least 60%, preferably at least 65%, more preferably at least 70%, more preferably at least 75%, and most preferably at least 78%. The intra-particle porosity is preferably no more than 87%, more preferably no more than 86%, and most preferably no more than 85%.

The intra-particle porosity of the porous particles may be measured by mercury porosimetry. Mercury porosimetry is a technique that characterises the porosity of a material by applying varying levels of pressure to a sample of the material immersed in mercury. The pressure required to intrude mercury into the pores of the sample is inversely proportional to the size of the pores. More specifically, mercury porosimetry is based on the capillary law governing liquid penetration into small pores. This law, in the case of a non-wetting liquid such as mercury, is expressed by the Washburn equation:

D=(1/P)·4γ·cos φ

wherein D is pore diameter, P is the applied pressure, γ is the surface tension, and φ is the contact angle between the liquid and the sample. The volume of mercury penetrating the pores of the sample is measured directly as a function of the applied pressure. As pressure increases during an analysis, pore size is calculated for each pressure point and the corresponding volume of mercury required to fill these pores is measured. These measurements, taken over a range of pressures, give the pore volume versus pore diameter distribution for the sample material. The Washburn equation assumes that all pores are cylindrical. While true cylindrical pores are rarely encountered in real materials, this assumption provides sufficiently useful representation of the pore structure for most materials. For the avoidance of doubt, references herein to pore diameter shall be understood as referring to the equivalent cylindrical dimensions as determined by mercury porosimetry. Values obtained by mercury porosimetry as reported herein are obtained in accordance with ASTM UOP574-11, with the surface tension γ taken to be 480 mN/m and the contact angle φ taken to be 140o for mercury at room temperature. The density of mercury is taken to be 13.5462 g/cm3 at room temperature.

For a sample in the form of a powder of porous particles, the total pore volume of the sample is the sum of intra-particle and inter-particle pores. This gives rise to an at least bimodal pore diameter distribution curve in a mercury porosimetry analysis, comprising a set of one or more peaks at lower pore sizes relating to the intra-particle pore diameter distribution and a set of one or more peaks at larger pore sizes relating to the inter-particle pore diameter distribution. From the pore diameter distribution curve, the lowest point between the two sets of peaks indicates the diameter at which the intra-particle and inter-particle pore volumes can be separated. The pore volume at diameters greater than this is assumed to be the pore volume associated with inter-particle pores. The total pore volume minus the inter-particle pore volume gives the intra-particle pore volume from which the intra-particle porosity can be calculated.

A number of high precision mercury porosimetry instruments are commercially available, such as the AutoPore IV series of automated mercury porosimeters available from Micromeritics Instrument Corporation, USA. For a complete review of mercury porosimetry reference may be made to P. A. Webb and C. Orr in “Analytical Methods in Fine Particle Technology, 1997, Micromeritics Instrument Corporation, ISBN 0-9656783-0.

It will be appreciated that mercury porosimetry and other intrusion techniques are effective only to determine the pore volume of pores that are accessible to mercury (or another fluid) from the exterior of the porous particles to be measured. As noted above, substantially all of the pore volume of the particles is accessible from the exterior of the particles, and thus porosity measurements by mercury porosimetry will generally be equivalent to the entire pore volume of the particles. Nonetheless, for the avoidance of doubt, intra-particle porosity values as specified or reported herein shall be understood as referring to the volume of open pores, i.e. pores that are accessible to a fluid from the exterior of the particles. Fully enclosed pores which cannot be identified by mercury porosimetry shall not be taken into account herein when specifying or reporting intra-particle porosity.

A sample of the high capacity electroactive porous particulate material is characterised by having at least two peaks in the pore diameter distribution as determined by mercury porosimetry, at least one peak at lower pore sizes being associated with intra-particle pores and at least one peak at higher pore sizes being associated with inter-particle porosity. The high capacity electroactive porous particulate material preferably has a pore diameter distribution having at least one peak at a pore size less than 350 nm, more preferably less than 300 nm, more preferably less than 250 nm, and most preferably less than 200 nm, as determined by mercury porosimetry. Preferably, the pore diameter distribution has at least one peak at a pore size of more than 50 nm, more preferably more than 60 nm, and most preferably more than 80 nm, as determined by mercury porosimetry.

Preferably the high capacity electroactive porous particulate material is also characterised by a peak in the pore diameter distribution of a loose packed plurality of particles relating to the inter-particle porosity at a pore size of no more than 1000 nm, as determined by mercury porosimetry.

The porous particles are preferably spheroidal in shape. Spheroidal particles as defined herein may include both spherical and ellipsoidal particles and the shape of the particles may suitably be defined by reference to their sphericity and aspect ratio. Spheroidal particles are found to be particularly well-suited to dispersion in slurries without the formation of agglomerates.

The sphericity of an object is conventionally defined as the ratio of the surface area of a sphere to the surface area of the object, wherein the object and the sphere have identical volume. However, in practice it is difficult to measure the surface area and volume of individual particles at the micron scale. However, it is possible to obtain highly accurate two-dimensional projections of micron scale particles by scanning electron microscopy (SEM) and by dynamic image analysis, in which a digital camera is used to record the shadow projected by a particle. The term “sphericity” as used herein shall be understood as the ratio of the area of the particle projection to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Am is the measured area of the particle projection and Cm is the measured circumference of the particle projection. The average sphericity Say of a population of particles as used herein is defined as:

$${S}_{av} = \frac{1}{n} {\sum }_{i = 1}^{n} [ \frac{4 \cdot π \cdot {A}_{m}}{{( {C}_{m} )}^{2}} ]$$

wherein n represents the number of particles in the population.

As used herein, the term “spheroidal” as applied to the particles shall be understood to refer to a material having an average sphericity of at least 0.70. Preferably, the high capacity electroactive porous particles have an average sphericity of at least 0.85, more preferably at least 0.90, more preferably at least 0.92, more preferably at least 0.93, more preferably at least 0.94, more preferably at least 0.95, more preferably at least 0.96, more preferably at least 0.97, more preferably at least 0.98 and most preferably at least 0.99.

The average aspect ratio of the porous particles is preferably less than 3:1, more preferably no more than 2.5:1, more preferably no more than 2:1, more preferably no more than 1.8:1, more preferably no more than 1.6:1, more preferably no more than 1.4:1 and most preferably no more than 1.2:1. As used herein, the term “aspect ratio” refers to the ratio of the longest dimension to the shortest dimension of a two-dimensional particle projection. The term “average aspect ratio” refers to a number-weighted mean average of the aspect ratios of the individual particles in the particle population.

It will be understood that the circumference and area of a two-dimensional particle projection will depend on the orientation of the particle in the case of any particle which is not perfectly spheroidal. However, the effect of particle orientation may be offset by reporting sphericity and aspect ratios as average values obtained from a plurality of particles having random orientation. A number of SEM and dynamic image analysis instruments are commercially available, allowing the sphericity and aspect ratio of a particulate material to be determined rapidly and reliably. Unless stated otherwise, sphericity values as specified or reported herein are as measured by a CamSizer XT particle analyzer from Retsch Technology GmbH. The CamSizer XT is a dynamic image analysis instrument which is capable of obtaining highly accurate distributions of the size and shape for particulate materials in sample volumes of from 100 mg to 100 g, allowing properties such as average sphericity and aspect ratios to be calculated directly by the instrument.

The high capacity electroactive porous particulate material preferably has a BET surface area of less than 300 m²/g, more preferably less than 250 m²/g, more preferably less than 200 m²/g, more preferably less than 150 m²/g, more preferably less than 120 m²/g. The high capacity electroactive porous particulate material may have a BET surface area of less than 100 m²/g, for example less than 80 m²/g. Suitably, the BET surface may be at least 10 m²/g, at least 15 m²/g, at least 20 m²/g, or at least 50 m²/g. The term “BET surface area” as used herein should be taken to refer to the surface area per unit mass calculated from a measurement of the physical adsorption of gas molecules on a solid surface, using the Brunauer-Emmett-Teller theory, in accordance with ASTM B922/10.

Control of the BET surface area of electroactive material is an important consideration in the design of anodes for metal ion batteries. A BET surface area which is too low results in unacceptably low charging rate and capacity due to the inaccessibility of the bulk of the electroactive material to metal ions in the surrounding electrolyte. However, a very high BET surface area is also known to be disadvantageous due to the formation of a solid electrolyte interphase (SEI) layer at the anode surface during the first charge-discharge cycle of the battery. SEI layers are formed due to reaction of the electrolyte at the surface of electroactive materials and can consume significant amounts of metal ions from the electrolyte, thus depleting the capacity of the battery in subsequent charge-discharge cycles. While previous teaching in the art focuses on an optimum BET surface area below about 10 m²/g, the present inventors have found that a much wider BET range can be tolerated.

Preferably, the high capacity electroactive porous particles comprise a network of interconnected irregular elongate structural elements comprising the electroactive material which may be described as acicular, flake-like, dendritic, or coral-like. This particle architecture is associated with an interconnected network of pores, preferably with a substantially even distribution of the pores throughout the particle. In preferred embodiments, the porous particles comprise networks of fine structural elements having an aspect ratio of at least 2:1 and more preferably at least 5:1. A high aspect ratio of the structural elements provides a high number of interconnections between the structural elements constituting the porous particles for electrical continuity.

The thickness of the structural elements constituting the porous particles is an important parameter in relation to the ability of the electroactive material to reversibly intercalate and release metal ions. Structural elements which are too thin may result in excessive first cycle loss due to excessively high BET surface area resulting in the formation of an SEI layer. However, structural elements which are too thick are placed under excessive stress during intercalation of metal ions and also impede the insertion of metal ions into the bulk of the silicon material. The high capacity electroactive porous particulate material provides an optimum balance of these competing factors due to the presence of structural elements of optimised size and proportions. Thus, the porous particles preferably comprise structural elements having a smallest dimension less than 300 nm, preferably less than 200 nm, more preferably less than 150 nm, and a largest dimension at least twice, and preferably at least five times the smallest dimension. The smallest dimension is preferably at least 10 nm, more preferably at least 20 nm, and most preferably at least 30 nm. Smallest dimensions can be determined using microscopy techniques such as SEM (Scanning Electron Microscopy) and TEM (Transmission Electron Microscopy). Suitably a sample of particles having a particle size distribution value of less than 3 are examined using SEM and the size of the smallest dimension is determined.

The electroactive material containing structural elements constituting the porous particles preferably comprise amorphous or nanocrystalline electroactive material having a crystallite size of less than 100 nm, preferably less than 60 nm. The structural elements may comprise a mixture of amorphous and nanocrystalline electroactive material. The crystallite size may be determined by X-ray diffraction spectrometry analysis using an X-ray wavelength of 1.5456 nm. The crystallite size is calculated using the Scherrer equation from a 2θ XRD scan, where the crystallite size d=K·λ/(B·Cos θB), the shape constant K is taken to be 0.94, the wavelength λ is 1.5456 nm, θB is the Bragg angle associated with the 220 silicon peak, and B is the full width half maximum (FWHM) of that peak. Suitably the crystallite size is at least 10 nm.

By the term porous particle fragment it should be understood to mean a particle comprising one or more structural elements derived from a network of interconnected irregular structural elements constituting a porous particle. Such fragments are described in GB 1115262.6.

Porous particle fragments are characterized by a minimum D50 diameter of at least 10 nm, more preferably at least 20 nm, and most preferably at least 30 nm. Preferably the porous particle fragments are characterised by a smallest D50 diameter of less than 300 nm, preferably less than 200 nm, more preferably less than 150 nm, and a largest D50 diameter of at least twice, and preferably at least five times the smallest dimension.

Pillared particle structures that can be included in the active material layer of the electrode are substantially as described in US 2011/0067228, US 2011/0269019 and US 2011/0250498 or are prepared using the techniques described in U.S. Pat. No. 7,402,829, JP 2004281317, US 2010/0285358, US 2010/0297502, US 2008/0261112 or WO 2011/117436.

Wires, fibres, rods or ribbons may have smallest dimensions as the diameter or minimum thickness of up to 2 microns, optionally about 0.1 microns, preferably 10 to 300 nm and may have lengths of more than 1 μm, optionally more than 5 μm with aspect ratios of at least 2:1, optionally at least 5:1, at least 10:1, at least 100:1 or at least 1000:1. The smallest dimensions may be at least about 10 nm. The ribbons may have widths that are at least twice the minimum thickness, optionally at least five times the minimum thickness. Flakes may have a thickness of at least 20 nm, and a thickness of up to about 20 microns or 10 microns, 2 microns, optionally about 0.1 microns, and other dimensions in the range of 5-50 microns.

The size, sphericity, BET values and inherent porosity of all the particulate materials disclosed herein can be determined using the techniques referred to above.

Fibres for inclusion in the active material layer of the electrode are substantially as described in U.S. Pat. No. 8,101,298. The fibres may be substantially solid or may include pores or voids distributed over the surface thereof. Flakes and ribbons for inclusion in the active material layer are substantially as described in US 2010/0190061 (which also may be substantially solid or have pores or voids distributed over the surface thereof).

The active material may comprise structures comprising at least 95 wt % elemental silicon (by weight of the structure). The particulate material suitably comprises structures comprising at least 98 wt % elemental silicon. Preferably the particulate material comprises structures comprising at least 99.90 wt % elemental silicon. Preferably the particulate material comprises structures comprising no more than 99.99 wt % elemental silicon. Preferably the particulate material comprises structures comprising no more than 99.96 wt % elemental silicon. Preferably the particulate material comprises structures comprising no more than 99.6 wt % silicon.

The particulate material may suitably comprise structures comprising an n-type silicon or a p-type silicon. Such structures may include impurities selected from the group consisting boron, nitrogen, tin, phosphorous, aluminium and germanium and mixtures thereof.

Preferably these impurities are present in an amount of no greater than 1% by weight of the silicon.

Alternatively or in addition, the particulate material may comprise structures comprising an electroactive silicon alloy. Optionally the electroactive silicon alloy comprises, in addition to silicon, one or more elements selected from the group consisting aluminium, titanium, boron, phosphorous, germanium, tin, lead, nickel, cobalt, manganese, molybdenum, chromium, vanadium, copper, iron, tungsten, titanium, zinc, alkali metal and an alkali earth metal. Preferably the electroactive silicon alloy comprises silicon

Alternatively or in addition, the particulate material may comprise structures comprising an electroactive compound of silicon. Optionally the electroactive compound of silicon is a silicon oxide, a silicon carbide or a silicon nitride.

In a further embodiment, the particulate material may further comprise a coating layer disposed over the treatment layer applied to the structure or structures comprising silicon. Optionally the coating layer comprises particulate carbon or pyrolytic carbon. Optionally the coating layer covers at least 40% of the surface of the particle. Optionally the coating layer comprises particulate carbon having a minimum dimension of at least 50 nm, preferably 100 nm. Optionally the coating layer comprises particulate carbon having a maximum dimension of no greater than 2 microns, preferably no greater than 1 micron, more preferably no greater than 200 nm, especially no greater than 100 nm.

Furthermore, it has been found that silicon structures with modified surfaces tend to attract carbon structures, for example, when both types of structures are dissolved in water. As noted above, the modified silicon structure has a positive zeta potential while carbon may have a negative zeta potential. By controlling the size of silicon structures and carbon structures, composite structures with silicon cores and carbon shells may be formed. For example, silicon particles may be between about 1 and 50 microns in size or, more specifically, between about 2 and 10 micrometers in size, while carbon particles can be less than about 1 micrometer in size or, more specifically, less than about 0.2 micrometers in size. These core-shell structures may be formed before mixing slurry for coating an electrode, for example, during a treatment process. Preferably a core-shell structure is formed after the treatment process and prior to electrode fabrication. Alternatively, the core-shell structures are formed while mixing the slurry, such as during electrode fabrication operations. The silicon core-carbon shell structure may include silicon-containing core, silicon dioxide layer around its core, treatment layer containing amine, imine, or other groups, and then an outer carbon layer. It should be noted that these layers do not have to be continuous and form a complete shell.

Composite structures including silicon cores and conductive carbon shells have shown improved performance relative to uncoated silicon particles in terms of capacity and stability of lithium ion cells. However, previously proposed processes by which these composite structures are made are expensive and hard to control. For example, one previous proposal involves dispersing silicon particles in a resorcinol/formaldehyde mixture and then polymerizing the phenolic resin with embedded silicon particles. The polymers is then pyrolyzed in nitrogen (or argon) to form carbon coating on the silicon particles and the pyrolysis products are ground to form fine particles for use in electrode fabrication operations. This results in the formation of a semi-continuous coating, which can limit the rate at which the silicon surface is lithiated.

In a further embodiment, the active material may also include a carbon containing layer covering at least a portion of the treatment layer. The carbon containing layer may include multiple carbon particles adsorbed or covalently bound to the treatment layer. In some embodiments, the external surface of the silicon containing structure includes silicon dioxide. Carbon coated treated particles are believed to be more easily dispersed within the graphite of the electrode material due to improved material compatibility. The carbon coating may also improve the conductivity of an electrode material include such particles.

Optionally the structures comprising silicon comprise a coating layer disposed between the core of the silicon structure and the treatment layer. Optionally the coating layer comprises carbon or silicon oxide.

In some embodiments, the particulate material further comprises a coating layer disposed over the treatment layer. The coating layer suitably comprises particulate carbon or pyrolytic carbon. Preferably the coating layer covers at least 40% of the surface of the particle. Preferably the coating layer comprises particulate carbon having a minimum dimension of at least 50 nm, preferably 100 nm. Preferably the coating layer comprises particulate carbon having a maximum dimension of no greater than 2 microns, preferably no greater than 1 micron, more preferably no greater than 200 nm, especially no greater than 100 nm.

Optionally the particulate material is characterised by a D50 value of at least 1 μm, preferably at least 2 μm, more preferably at least 3 μm, especially at least 5 μm. Optionally the particulate material is characterised by a D50 value of no greater than 40 μm, preferably no greater than 30 μm, especially no greater than 15 μm. Optionally the particulate material is characterised by a BET value of at least 10 m²/g, preferably at least 15 m²/g, more preferably at least 20 m²/g, especially at least 50 m²/g. Optionally the particulate material is characterised by a BET value of no greater than 300 m²/g, preferably no greater than 250 m²/g, more preferably no greater than 100 m²/g, most preferably no greater than 150 m²/g, especially no greater than 120 m²/g.

The active material may form part of a composite material for use in an electrochemical cell; such composite materials comprise an active material and a polymeric binder provides a composite material for use in an electrochemical cell. The composite material suitably comprises an active material and at least 5 wt % of a polymeric binder based on the dry weight of the composite material.

The composite material preferably comprises a polymeric binder selected from the group consisting polyacrylic acid, polysulphonic acid, polyalkylanhydride, carboxymethylcellulose, styrene butadiene rubber, polyalkylacid halides, polyalkylsulphonyl cholorides, polyvinylenedifluoride and derivatives and salts thereof. Preferably the polymer binder has a number average molecular weight in the range 50,000 to 1,000,000, More preferably 100,000 to 500,000. The polymer binder is suitably a polyacrylic acid having a molecular weight in the range 150,000 to 450,000. Alternatively the polymer binder is a functionalised polyvinylenedifluoroide having a molecular weight in the range 150,000 to 450,000. Preferably the polymer binder is a linear polymer binder.

The composite material typically comprises 5 to 95 wt % of the active particulate material and at least 5 wt % of a polymeric binder based on the dry weight of the composite material. Optionally the composite material comprises an active material, a polymeric binder and one or more species selected from graphite and a conductive carbon. Optionally the composite material comprises 5 to 80 wt % of an active material, 5 to 15 wt % of a polymeric binder, 0 to 15% of graphite and 0 to 10 wt % of a conductive carbon. Preferably the graphite in the active material is selected from a synthetic or natural graphite having a crystallite length of greater than 50 nm, preferably greater than 100 nm. Preferably the graphite in the active material has a D50 diameter in the range 10 to 50 μm, preferably 10 to 40 μm, more preferably 10 to 30 μm and especially 10 to 25 μm. More preferably the graphite in the active material is selected from Timrex®, SFG6®, SFG10R®, SFG15®, KS4® and KS6®. Hard carbons and soft carbons may also be used.

The conductive carbon in the active material is suitably selected from one or more of the group comprising carbon black, ketjen black, lamp black, carbon nanotubes and vapour grown carbon fibres. Preferably the conductive carbon in the active material has at least one dimension less than 1 μm, preferably less than 500 nm especially less than 200 nm.

Preferably the polymeric binder of the active material is covalently bound to the treatment material of the particulate material, the treatment material being disposed on the surface of the silicon structure.

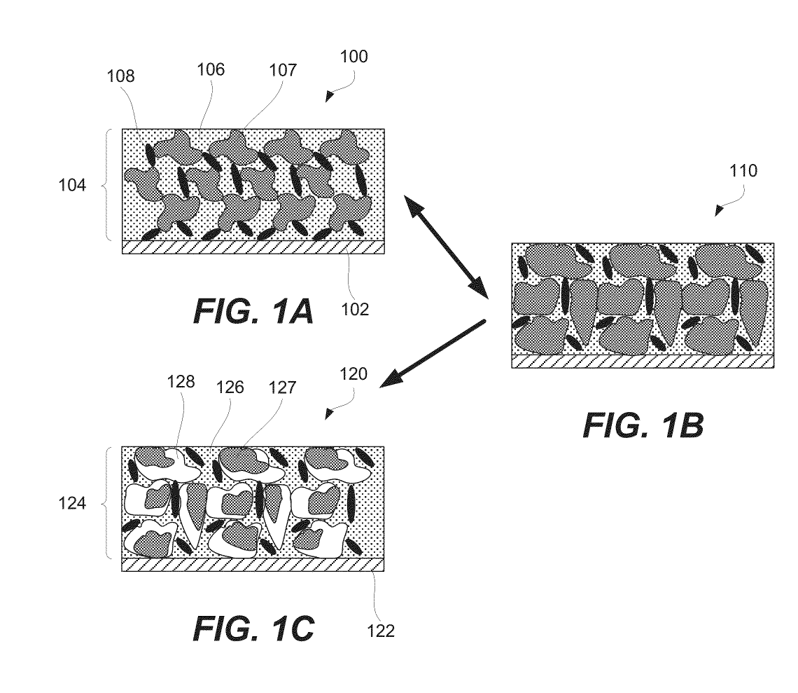

Bonding between the active materials particles and the binder in an electrode and its effect on the cycle life will now be described with reference to FIGS. 1A-1C. Specifically, FIG. 1A is a schematic illustration of an electrode 100 in its discharge state, in accordance with some embodiments. Electrode 100 includes a current collector substrate 102 and an active material layer 104 disposed over and adhered to current collector substrate 102. Active material layer 104 also includes binder 106 and active material structures 107. In some embodiments, active material layer 104 may also include conductive additive 108, such as conductive carbon additive. When lithium is added to active material structures 107, these structures 107 may increase in size as shown by a transition from FIG. 1A to FIG. 1B. Electrode 100 shown in FIG. 1A may be referred to as a discharged electrode, while electrode 110 shown in FIG. 1B may be referred to as a charged electrode. The terms “charged” and “discharged” are relative and correspond to relative amounts of lithium in the electrodes or, more specifically, in active material structures. Addition of lithium into the active material structures may cause swelling of these structures. For example, silicon structures swell by as much as 400% when charged to silicon's theoretical capacity. As the active materials particles swell, they push on other components of the active material layer and rearrange these other components in the layer. Examples of these other components include binder and conductive additive particles, when these particles are used. In some embodiments, the thickness of the active material layer may also change.

When lithium is removed during discharge, the active material particles shrink and pull away from other components of the active material layer. If the bonding between the active material particles and the binder is sufficiently strong, these shrinking active material particles will pull these other components and may retain mechanical and, as a result, electrical connections with these other components. Even though some changes may occur within the active material layer during each charge-discharge cycle, as long as these changes do not electrically disconnect a significant portion the active material particles from the current collector substrate, the capacity of the electrode will remain substantially the same. As such, the bonding strength between the active material particles and binder molecules is believed to play an important role in capacity retention, particularly when high capacity active materials are used.

However, if the bonding strength between the active material structures and the binder is weak, the discharge process may cause some active materials structures or clusters of the active material structures to become electrically disconnected from the current collector substrate. As a result, these structure and/or clusters are not exposed to an operating potential of the negative electrode and do not contribute to the capacity during subsequent cycling. This phenomenon is schematically presented in FIG. 1C. Specifically, FIG. 1C illustrates an electrode in which voids 128 exists within active material layer 124. The voids may be between binder 126 and active material structures 127, between adjacent active material structures 127. Voids 128 may be created when active material structures 127 first swell during charge and push away other components and then shrink during discharge without being able to pull other components and fill the entire volume previously occupied by the swollen active material particles. Voids 128 may cause active material structures 127 become disconnected from current collector substrate 122 and not contribute to cycling capacity.

Without being restricted to any particular theory, it is believed that a combination of strong adhesion between active material particles and binder as well as a high tensile strength of the binder helps to maintain electrical connections within an active material layers needed for long cycle life. While elastic binders, such as PVDF, may help to prevent voids in the active material layer, low tensile strength exhibited by PVDF may not be sufficient to retain mechanical and electrical connections within an electrode layer during discharge. Among PAA, PVDF, CMC, SBR, and alginates binders, the PAA binder is considered to have the highest tensile strength, followed by CMC, SBR, and alginates, and finally PVDF. However, the tensile strength on its own is not sufficient. The tensile strength needs to be coupled with strong bonding between the binder and active material structure, which is achieved by treating the active materials structures using techniques described herein.

In addition to maintaining electronic conductivity within an electrode, treatment of the active materials structures is believed to help with controlling ionic conductivity. First, electrodes are typically fabricated with a predetermined porosity, such as 30%. The porosity facilitates transport of electrolyte solution to the electrode active materials. The open pores may also help accommodate the volume expansion of the active material structures upon lithiation without causing fracture. The treatment helps with uniform distribution of active material particles throughout the electrode layer and uniform porosity.

The active material may be readily fabricated by a person skilled in the art and provides a method for fabricating an active material for use in an electrochemical cell, the method comprising the steps of:
a. Providing a solution of the treatment material in a carrier solvent;
b. Combining the solution of step (a) with structures comprising silicon to form a slurry;
c. Adjusting the pH of the slurry to a value of between pH 3 and pH6; and
d. mixing the slurry, thereby to facilitate the formation of a treatment layer over at least a portion of the structure comprising silicon.

The step of mixing the slurry at a pH of between pH3 and pH6 is suitably carried out at a temperature of between 10° C. and 60° C.

The method suitably further comprises the step of removing the carrier solvent. Preferably the carrier solvent is removed at a temperature in the range 40 to 100° C.

Preferably the method further comprises the step of heat treating the treated structures comprising silicon thereby to anchor the treatment material to the surface of the silicon. The heat treatment step is suitably carried out at a temperature of between 80° C. and 140° C., preferably between 80° C. and 130° C.

Suitably the method further comprises the step of providing a coating over the surface of the treatment layer. Preferably the coating covers no more than 90% of the surface of the particle. Suitably the coating comprises particulate carbon or pyrolytic carbon. Preferably the coating comprises a particulate carbon having a D50 diameter of less than 2 microns, preferably less than 1 micron, especially less than 0.2 microns.

The method can be extended to the fabrication of a composite material for use in an electrochemical cell. Such materials suitably comprise an active material and a polymeric binder. In some embodiments, the method provides the steps of:
a. forming a particulate material comprising a structure comprising silicon having an external surface and a treatment layer covering at least a portion of the external surface;
b. Forming a solution of the polymer binder in a carrier solvent; and
c. Combining the solution of the polymer binder with the particulate material of (a) to form a slurry and drying the slurry to form the active material.

Preferably the method further comprises the step of combining the slurry formed in step (c) with one or more species selected from a graphite as defined herein above and a conductive carbon as defined herein above.

Preferably the method further comprises the step of heat treating the active material obtained from drying the slurry. The heat treatment suitably causes the linear polymer to bond to the layer of the treatment material on the external surface of the silicon particles. Preferably the heat treatment is carried out at a temperature of from 80 to 180° C.

The solution of the polymer binder in the carrier solvent suitably comprises no more than 20 wt % of the polymer.

The slurry formed by combining the solution of the polymer binder with the particulate material preferably comprises at least 0.001 Kg (silicon particles)/Kg (carrier solvent) silicon particulate material, preferably at least 0.003 Kg/Kg and especially 0.005 kg/Kg. Preferably the slurry formed comprises no more than 0.03 kg/kg silicon particulate material. Preferably the slurry formed comprises at least 150 m² (particulate surface)/l, more preferably at least 200 m²/g and especially 265 m²/g.

Examples of Treatment and Active Materials Structures

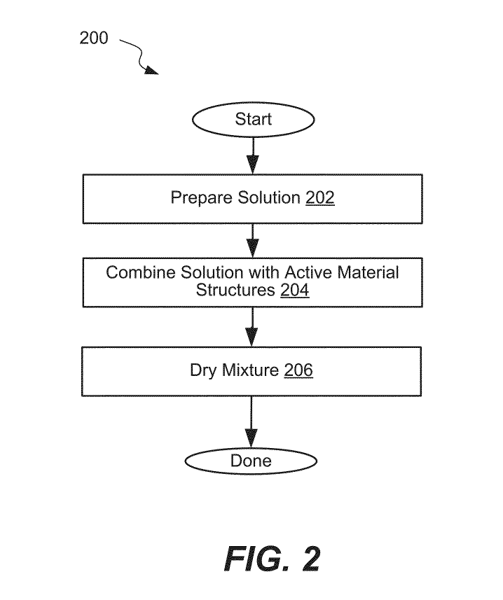

FIG. 2 is a process flowchart of a method 200 for treating active material structures to enhance their bonding characteristics, in accordance with some embodiments. Method 200 may start with preparing a solution containing a treating agent. Some examples of treating agents include amino-silanes, poly(amines), and/or poly(imines), such as aminopropyltriethoxysilane, aminopropyltrimethoxysilane, bis-gamma-trimethoxysilypropyl amine, aminoneohexyltrimethoxysilane, aminoneohexylmethyldimethoxysilane, poly(ethyleneimine) and polye(allylamine). For example, Silquest® Y-15744 (available from Momentive Performance Materials Inc. in Columbus, Ohio) may be dissolved in an acidified mixture of alcohol and de-ionized water. The volumetric concentration of the treating agent may be between about 0.2% and 10% or, more specifically, between about 1% and 5%. These concentration ranges may be based on the volume of 100 g silicon structures with density 4 g/cc. When using the adsorption technique, treatment of active material, for example, with an aqueous 0.5 wt. % solution of poly(ethyleneimine), will impart the desired surface modification.

Method 200 may proceed with combining the solution (containing the treating agent) with active material structures during operation 204. In some embodiments, the active material structures include silicon, tin, and/or germanium. The structures including silicon may be referred to as silicon containing structures. In some embodiments, the active material structures may include multiple materials, such as silicon and carbon, silicon-tin alloy, or other types of combinations. These multiple materials may be presented in different types of structures or in the same type structures. For example, a solution may be combined with silicon containing structures and carbon containing structures such that the silicon containing structures are not parts of the carbon containing structures at least prior to operation 204. In some embodiments, the same type of structures may include both silicon and carbon prior to operation 204. For example, structures that include silicon cores and carbon shells may be used. In some embodiments, the method may also involve combining the solution with carbon containing structures such that the carbon containing structures form a layer over the silicon containing structures.

In some embodiments, operation 204 may include mixing the solution with the active material particles to ensure uniform distribution of the solution and uniform coverage of the surface of the active material particles with the solution or more specifically with a treating agent. In some embodiments, the temperature of the mixture may be kept at between about 10° C. and 60° C. In the same or other embodiments, the acidity of the mixture may be kept between about 4.5 pH and 5.5 pH, with acetic acid, when using the technique of amino-silanization.

The amount of the treatment agent may depend on the surface area of the active material particles. For example, active material particles with the surface area of 2.65 m²/g may receive between about 0.1 ml and 1 ml of the treatment agent for 100 g of particles or between about 0.1 ml and 1 ml of the treatment agent for 265 m² of the surface area of the active material particles. Excessive amounts of the treatment agent may negatively impact the performance of the cell, generating undesired by-products, or toxicity. The excess amount of the treatment agent may be removed, in some embodiments, by washing off the active material particles using a solvent that does not contain the treating agent. The washing process may be repeated multiple times and controlled by monitoring, for example, a pH level of the washing solution. On the other hand, insufficient amounts of the treatment agent may not provide adequate bonding to the binder. Another factor that may impact the amount of the treatment agent is the material of the active material particles.

Without being restricted to any particular theory, it is believed that amino-silanization of silicon is different from poly(amine) adsorption. In the adsorption process both silicon and the carbon based active material can be surface modified. For example, silicon particles may be treated with an aqueous solution of poly(ethyleneimine) (PEI) to form a mono-molecular adsorbate on the surface of these particles. Once the adsorbate is formed, the particles become positively charged in water. The particles may be combined with carbon containing particles, which are negatively charged in water. This causes an electrostatic association to decorate the silicon particles with carbon based particles and to give composite particles with a negative charge. Any excess of carbon based particles that did not associate with the silicon particles remained negatively charged. Finally, further addition of poly(ethyleneimine) solution may add a positive charge (=—NRH₂⁺, where R═H or —CH₂—) to all particles. To make an electrode, the particle mixture may be dispersed in a binder solution. For example, poly(acrylic acid) partially neutralized with sodium hydroxide may be used. This binder adsorbs to the poly(ethyleneimine) surface layers on the silicon and carbon based particles to form a poly(ammonium acrylate salt). After removal of water and heating that salt converts to a poly(amide) to give a strong interfacial bond between particles and the poly(acrylic acid) matrix.

In some embodiments, before combining active material particles with the solution, the active material particles may be pre-treated to, for example, controllably form an oxide layer on the surface of the particles.

Method 200 may proceed with drying the mixture during operation 206. During this operation, the solvents used to prepare a treatment agent solution may be removed. Drying may be performed in stages. For example, operation 206 may start with air drying, followed by drying at about 60° C. (e.g., for about 2 hours) and finally curing at about 100° C. (e.g., for about 1 hour). Drying in stages ensures smooth removal of the alcohol at a lower temperature and then water at a higher temperature when both alcohol and water are used in the solution. Furthermore, a condensation reaction, in which the Si—O—R linkage is formed, may be triggered at a higher temperature, such as greater than 80° C., such as about 100° C. The condensation reaction establishes bonds between the silane molecule and the silicon particle. This staged drying process also avoids sudden generation of steam within the mixture, which can cause undesirable porosity or other damaging effects. In some embodiments, the drying process involves drying for 24 hrs at a room temperature, followed by 30 minutes at 100° C. or 10 minutes at 120° C.

In some embodiments, operation 206 also involves heat treatment. The heat treatment may adoptively or covalently anchor the one or more treatment materials to the external surfaces of the silicon containing structures. The heat treatment may be performed at a temperature of between about 80° C. and 130° C.

In some embodiments, the treatment agent forms a covalent bond with the surface of the active material particles. As such, the treatment agent becomes an integral part of the active material structures and gets anchored on the surface of these structures. The other end of the treatment agent, which carries the amine group, is available for bonding to the carboxylic acid group on the binder polymer, such as PAA.

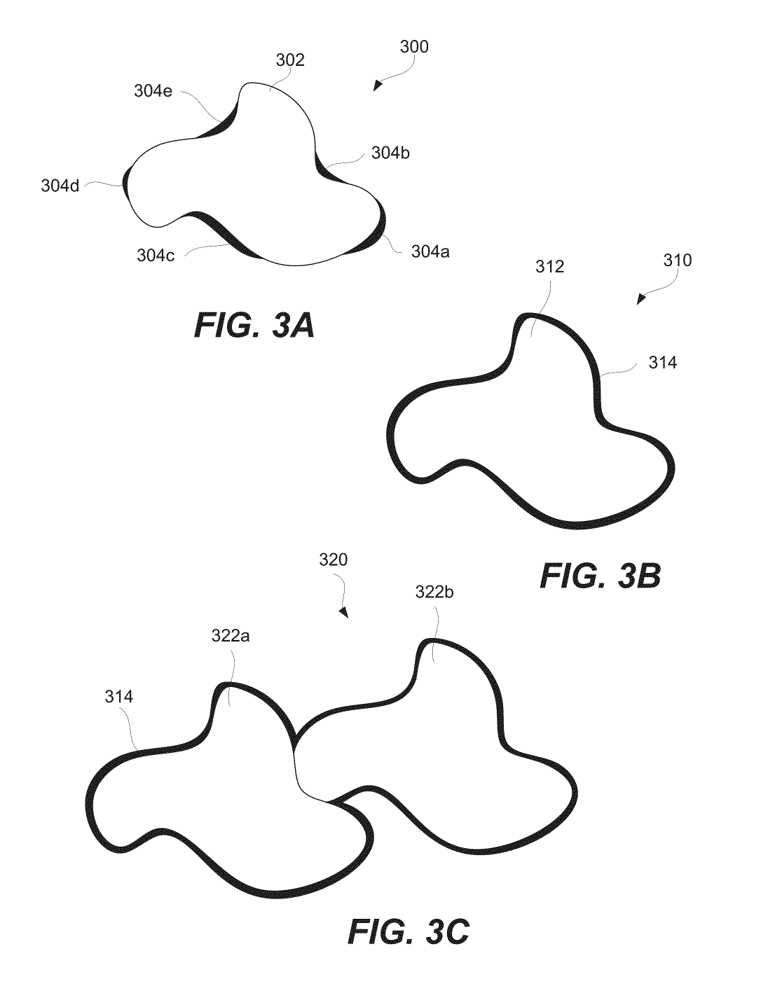

The output of operation 206 may be active material structures with treated surfaces. The treated active material structures may form soft aggregates that easily disperse during further processing, such as mixing slurry. FIGS. 3A-3C illustrate different examples of treated active material structures. Specifically, FIG. 3A illustrates a treated active material structure 300 that has only portions of its surface covered with a treatment agent forming patches 304a-304e. Portions of original active material structure 302 remain uncovered by the treatment agent. FIG. 3B illustrates a treated active material structure 310 that has its entire surface covered with a treatment agent thereby forming a core 312 of the original active material structure and a shell 314 of the treatment agent. FIG. 3C illustrates a treated active material agglomerate 320 that includes two active material structures 322a and 322b enclosed into the same shell 314. When and if this agglomerate falls apart, portions of active material structures 322a and 322b may remain uncovered.

The active materials and composites described herein can be used to manufacture electrodes for use in an electrochemical cell. Also provided is an electrode comprising an active material and a current collector. In some embodiments, also provided is an electrode comprising a composite material and a current collector.

The electrodes may be simply fabricated by a skilled person. Also provided is a method of fabricating an electrode comprising an active material. The method may involve the steps of forming a slurry including an active material and a binder, casting the slurry onto a current collector and drying the slurry. The method may comprise the further step of heat treating the electrode after the slurry is dried or as part of the drying process. The active material includes silicon containing structure individually covered with a layer of a treatment material having. Preferred treatment materials include one or more of the following materials: an aminosilane, a poly(amine), and a poly(imine). The binder may include poly acrylic acid (PAA), a carboxymethyl cellulose, a functionalised PVDF or a polysulphonic acid. The method may proceed with coating the slurry onto a substrate and drying the slurry. Also included is an electrochemical cell comprising an active material. Also provided is a device comprising an active material.

Examples of Fabrication and Electrochemical Cells

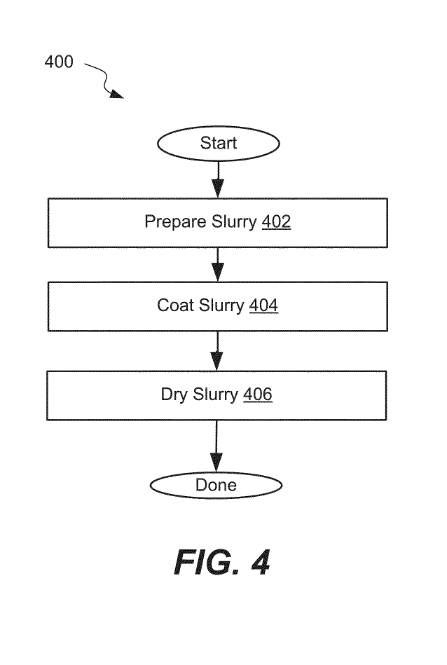

FIG. 4 is a process flowchart corresponding to a method 400 of forming an electrode using treated active material structures, in accordance with some embodiments. Method 400 may start with preparing a slurry during operation 402. The treated active material structures may be mixed with a binder. In some embodiments, multiple different active material structures may be mixed into the same slurry. At least one of these different structures may be treated in accordance with techniques described above. Other types of structures may be untreated. For example, treated silicon particles may be combined in the same slurry with untreated graphite particles.

In some embodiments, silicon particles either surface modified by amino-silanization or by poly(amine) adsorption readily disperse in the aqueous binder solution of partially neutralized (pH˜6) poly(acrylic acid). Carbon-based particles surface modified by poly(amine adsorption) or after being deposited on the silicon particles and then surface modified by poly(amine) adsorption show the same wetting and dispersion behaviour.

Method 400 may proceed with coating the slurry onto a conductive substrate (operation 404) and drying the slurry onto the substrate (operation 406). In some embodiments, in order to reduce effects of delamination and/or deformation of the substrate when the active materials particles expand and contract during cycling, a substrate with a nodular surface may be used. In the same or other embodiments, a substrate may include copper metal alloys or laminates (e.g., copper electroplated on another substrate with a higher mechanical strength), nickel or other metal foil.

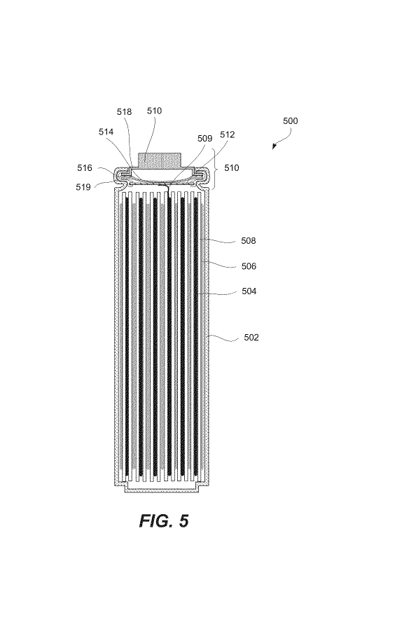

FIG. 5 illustrates a schematic cross-section view of the wound cylindrical cell 500, in accordance with some embodiments. Positive electrode 506, negative electrode 504, and separator strips 508 may be wound in to a so-called “jelly roll,” which is inserted into a cylindrical case 502. Specifically, the jelly roll includes a spirally wound assembly of positive electrode 506, a negative electrode 504, and two strips of separator 508.

Case 502 may be rigid, in particular for lithium ion cells. Other types of cells may be packed into a flexible, foil-type (polymer laminate) case. A variety of materials can be chosen for case 502. The selection of case materials depend in part on polarity of case 502. If case 502 is connected to positive electrode 506, then case 502 may be formed from titanium 6-4, other titanium alloys, aluminum, aluminum alloys, and 300-series stainless steel. On the other hand, if case 502 is connected to negative electrode 504, then case may be made from titanium, titanium alloys, copper, nickel, lead, and stainless steels. In some embodiments, case 502 is neutral (i.e., have a different potential than the positive electrode or the negative electrode) and may be connected to an auxiliary electrode made, for example, from metallic lithium. An electrical connection between case 502 and an electrode may be established by a direct contact between case 502 and this electrode (e.g., an outer wound of the jelly roll), by a tab connected to the electrode and case 502, and other techniques. Case 502 may have an integrated bottom. Alternatively, a bottom may be attached to the case by welding, soldering, crimping, and other techniques. The bottom and the case may have the same or different polarities (e.g., when the case is neutral).

The top of case 502, which is used for insertion of the jelly roll, may be capped with header assembly 510. In some embodiments, header assembly 510 includes a weld plate 512, a rupture membrane 514, a PTC-based resettable fuse 516, header cup 518, and insulating gasket 519. Weld plate 512, rupture membrane 514, PTC-based resettable fuse 516, and header cup 518 are all made from conductive material and are used for conducting electricity between an electrode (negative electrode 504 in FIG. 5) and cell connector 520 (integrated or attached to header cup 518 in FIG. 5). Insulating gasket 519 is used to support the conductive components of header assembly 510 and insulate these components from case 502. Weld plate 512 may be connected to the electrode by tab 509. One end of tab 509 may be welded to the electrode (e.g., ultrasonic or resistance welded), while the other end of tab may be welded to weld plate 512. Centers of weld plate 512 and rupture membrane 514 are connected due to the convex shape of rupture membrane 514. If the internal pressure of cell 500 increases (e.g., due to electrolyte decomposition and other outgassing processes), rupture membrane 514 may change its shape and disconnect from weld plate thereby breaking the electrical connection between the electrode and cell connector 520.

PTC-based resettable fuse 516 is disposed between edges of rupture membrane 514 and edges of header cup 518 effectively interconnecting these two components. At normal operating temperatures, the resistance of PTC-based resettable fuse 516 is low. However, its resistance increases substantially when PTC-based resettable fuse 516 is heated up due to, e.g., heat released within cell 500. PTC-based resettable fuse is a thermally activated circuit breaker that can electrically disconnect rupture membrane 514 from header cup 518 and, as a result, disconnect the electrode from cell connector 520 when the temperature of PTC-based resettable fuse 516 exceeds a certain threshold temperature. In some embodiments, a cell or a battery pack may use a negative thermal coefficient (NTC) safety device in addition to or instead of a PTC-based resettable fuse.

Header cup 518 is an external component of header assembly 510. It may be attached to or be integrated with cell connector 520. The attachment or integration may be performed prior to forming header assembly 510 and/or attaching header assembly 510 to case 502. As such, high temperatures, mechanical stresses, and other generally destructive characteristics may be used for this attachment and/or integration.

Types of electrochemical cells are determined by active materials used on positive and negative electrodes as well as composition of electrolyte. Some examples of positive active materials include Li(M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g., Li(Co_{X}Ni_{1-X})O₂ and Li(Co_{X}Fe_{1-X})O₂), Li_{1-W}(Mn_{X}Ni_{Y}Co_{Z})O₂, (e.g., Li(Co_{X}Mn_{Y}Ni_{(1-x-Y)}O₂, Li(Mn_{1/3}Ni_{1/3}Co_{1/3})O₂, Li(Mn_{1/3}Ni_{1/3}CO_{1/3-x}Mg_{X})O₂, Li(Mn_{0.4}Ni_{0.4}Co_{0.2})O₂, Li(Mn_{0.1}Ni_{0.1}Co_{0.8})O₂,) Li_{1-W}(Mn_{X}Ni_{X}Co_{1-2X})O₂, Li_{1-W}(Mn_{X}Ni_{Y}CoAl_{W})O₂, Li_{1-W}(Ni_{X}Co_{Y}Al_{Z})O₂ (e.g., Li(Ni_{0.8}CO_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X-Y}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiM_{n1-X}Al_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g., LiV₃O₈, LiV₂O₅, and LiV₆O₁₃, LiMPO₄ where M is a metal; lithium iron phosphate (LiFePO₄) is a common example. It is both inexpensive and has high stability and safety, because the relatively strong phosphate bonds tend to keep the oxygen in the lattice during overcharge, but has poor conductance and requires substantial amounts of conductive additives, LiM_{X}M″_{1-X}PO₄ where M′ and M″ are different metals (e.g. LiFePO₄), LiFe_{X}M_{1-X}PO₄, where M is a metal, LiVOPO₄Li₃V₂(PO₄)₃, LiMPO₄, where M is a metal such as iron or vanadium. Further, a positive electrode may include a secondary active material to improve charge and discharge capacity, such as V₆O₁₃, V₂O₅, V₃O₈, MoO₃, TiS₂, WO₂, MoO₂, and RuO₂.

The selection of positive electrode materials depends on several considerations, such as cell capacity, safety requirements, intended cycle life, etc. Lithium cobalt oxide (LiCoO2) may be used in smaller cells that require higher gravimetric and/or volumetric capacities, such as for portable electronics and medical devices. Cobalt may be partially substituted with Sn, Mg, Fe, Ti, Al, Zr, Cr, V, Ga, Zn, or Cu. Certain materials, such as lithium nickel oxide (LiNiO2), may be less prone to thermal runaway. Other materials provide substantial cost advantage, such as lithium manganese oxide (LiMnO2). Furthermore, lithium manganese oxide has a relatively high power density because its three-dimensional crystalline structure provides more surface area, thereby permitting more ion flux between the electrodes.

Active materials may be deposited as layers on conductive substrates for delivering electrical current between the active materials and cell terminals. Substrate materials may include copper and/or copper dendrite coated metal oxides, stainless steel, titanium, aluminum, nickel (also used as a diffusion barrier), chromium, tungsten, metal nitrides, metal carbides, carbon, carbon fiber, graphite, graphene, carbon mesh, conductive polymers, or combinations of above including multi-layer structures. The substrate material may be formed as a foil, films, mesh, laminate, wires, tubes, particles, multi-layer structure, or any other suitable configurations. In one example, a substrate is a stainless steel foil having thickness of between about 1 micrometer and 50 micrometers. In other embodiments, a substrate is a copper foil with thickness of between about 5 micrometers and 30 micrometers. In yet another embodiment, a substrate is an aluminum foil with thickness of between about 5 micrometers and 50 micrometers.

In some embodiments, a separator material may include a fabric woven from fluoro-polymeric fibers of poly(ethylene-co-tetrafluoroethylene (PETFE) and poly(ethylenechloro-co-trifluoroethylene) used either by itself or laminated with a fluoropolymeric microporous film. Moreover, a separator materials may include, polystyrenes, polyvinyl chlorides polypropylene, polyethylene (including LDPE, LLDPE, HDPE, and ultra high molecular weight polyethylene), polyamides, polyimides, polyacrylics, polyacetals, polycarbonates, polyesters, polyetherimides, polyimides, polyketones, polyphenylene ethers, polyphenylene sulfides, polymethylpentene, polysulfones non-woven glass, glass fiber materials, ceramics, a polypropylene membrane commercially available under the designation CELGARD from Celanese Plastic Company, Inc. in Charlotte, N.C., USA, as well as Asahi Chemical Industry Co. in Tokyo, Japan, Tonen Corporation, in Tokyo, Japan, Ube Industries in Tokyo, Japan, and Nitto Denko K.K. in Osaka, Japan. In one embodiment, a separator includes copolymers of any of the foregoing, and mixtures thereof.

A typical separator has the following characteristic: air resistance (Gurley number) of less than about 800 seconds, or less than about 500 seconds in a more specific embodiment; thickness of between about 5 μm and 500 μm, or in specific embodiment between about 10 μm and 100 μm, or more specifically between about 10 μm and 30 μm; pore diameters ranging from between about 0.01 μm and 5 μm or more specifically between about 0.02 μm and 0.5 μm; porosity ranging from between about 20% and 85%, or more specifically, between about 30% and 60%.

The electrolyte in lithium ions cells may be liquid, solid, or gel. Lithium ion cells with the solid electrolyte are also referred to as a lithium polymer cells. A typical liquid electrolyte includes one or more solvents and one or more salts, at least one of which includes lithium. During the first charge cycle (sometimes referred to as a formation cycle), the organic solvent in the electrolyte can partially decompose on the negative electrode surface to form a solid electrolyte interphase layer (SEI layer). The interphase also prevents decomposition of the electrolyte in the later charging sub-cycles.

Some examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), and organic compounds containing an S═O or SO2 group (e.g., dimethyl sulfone and divinyl sulfone), and combinations thereof.

Examples of solvents that may be present in the initial electrolyte include cyclic carbonates (e.g., ethylene carbonate (EC) and propylene carbonate (PC)), linear carbonates (e.g., dimethyl carbonate (DMC), diethyl carbonate (DEC), and ethylmethyl carbonate (EMC)), fluorinated versions of the cyclic and linear carbonates (e.g., monofluoroethylene carbonate (FEC)). Furthermore, non-carbonate solvents, such as sulfones, nitriles, dinitriles, esters, and ethers, may be used.

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester.

Moreover, a cyclic carbonate may be combined with a lactone and a linear ester. In a specific embodiment, the ratio of a cyclic carbonate to a linear ester is between about 1:9 to 10:0, preferably 2:8 to 7:3, by volume.

A salt for the electrolytes may include one or more of the following: LiPF₆, LiBF₄, LiClO₄LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)2xLi), and combination of thereof. Common combinations include LiPF₆ and LiBF₄, LiPF₆ and LiN(CF₃SO₂)₂, LiBF₄ and LiN(CF₃SO₂)₂.

In one embodiment the total concentration of salt in a liquid non-aqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, no more than about 1.5 M.

### EXPERIMENTAL RESULTS

### Example 1

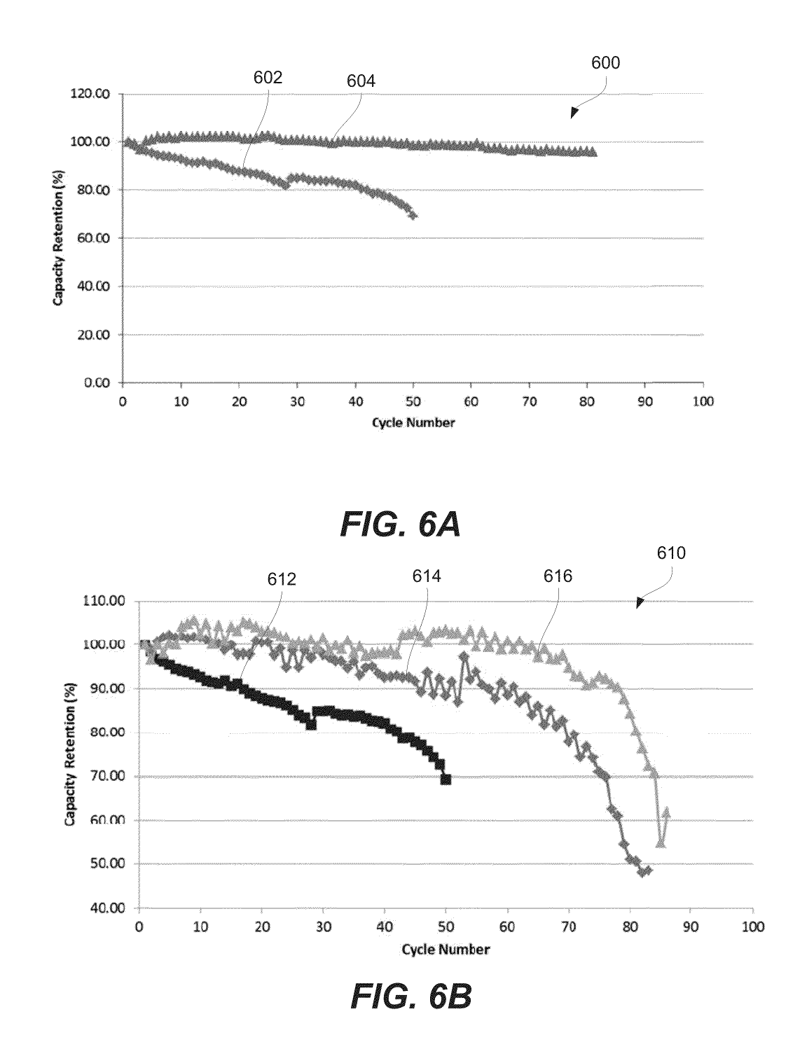

FIG. 6A illustrates a cycling data plot 600 for two cells fabricated using different negative active materials. Specifically, line 602 represents cycling data of a control cell fabricated using untreated silicon alloy particles. Line 604 represents cycling data of a controlled cell fabricated using silicon alloy particles treated with aminosilane.

Before treatment the silicon particles were the same as for the control cell. The treatment process involves mixing the silicon particles with a solution of aminofunctional organoalkoxysiloxane, Silquest® Y-15644 (available from Momentive Performance Materials Inc. in Columbus, Ohio). For each 100 grams of the silicon particles, 0.25 milliliters of the organoalkoxysiloxane was used. The organoalkoxysiloxane was first dissolved in an acidified mixture of DI water and reagent-grade ethanol to form an organoalkoxysiloxane solution. For each 0.25 milliliters of the organoalkoxysiloxane, 11 milliliters of the alcohol-water mixture, plus a drop of glacial acetic acid, was used. The volume ratio of the alcohol to water in the mixture was 10:1. The drop of glacial acetic acid lowers the pH of the solution to 4.5-5.5. The organoalkoxysiloxane solution was swirled for about five minutes to hydrolyze the alkoxy groups. The freshly prepared organoalkoxysiloxane solution was then added drop-wise to the silicon particles while blending. The silane-treated silicon particles were dried two hours in air at room temperature, followed by two hours in an oven at 60° C. and finally cured for an hour at 100° C. As noted above, staged drying removes the alcohol and water at a moderate rate and prevents steam formation within the mixture. Furthermore, raising the temperature to 100° C., after removing most of the alcohol and water, causes a condensation reaction between the —OH groups in the hydrolyzed organoalkoxysiloxane end of the molecule and the Si—OH groups on the surface of the silicon particles. This condensation reaction forms a Si—O—R type of link between the silicon particles and the siloxane additives. The organoalkoxysiloxane treated silicon particles were then used in preparation of a slurry, electrode, and cell in accordance to the procedure described above with reference to the control cell.

Both cells had negative electrodes including 60% by weight of the silicon particles (treated or untreated), 28% by weight of graphite, 2% by weight of conductive carbon (Super P), and 10% by weight of PAA binder. Half-cells were constructed using these negative electrodes. Lithium metal was used as a positive electrode. The electrolyte included a mixture of ethylene carbonate, di-ethylene carbonate, LiPF₆, and imide salts, as well as an additive.

Both cells were cycled at the same conditions. Cycling was performed between 0.005V and 0.9 V. The first two cycles were performed at a rate of C/20, respectively, followed by continuous cycling at C/5. As could be seen from FIG. 6A, the cell fabricated using the organoalkoxysiloxane treated silicon particles demonstrated much longer and more stable cycle life in comparison with the cell fabricated using the untreated silicon particles (i.e., the control cell). The capacity of the control cell started fading below 80% of the initial capacity after only 40 cycles, while the capacity of the cell with the organoalkoxysiloxane treated silicon particles maintained more than 95% of its initial capacity even after 80 cycles. Without being restricted to any particular theory, it is believed that some of the untreated silicon structures become electrically disconnected from the current collector due to their separation from other conductive materials in the electrode. This separation is believed to be caused by the weak bond between the untreated silicon structures and the binder. On the other hand, the treated silicon structures form stronger bonds to the binder and this bond held these treated silicon structures to better maintain the electrical connections to other conductive materials in the electrode and as a result to the current collector.

### Example 2

FIG. 6B illustrates a cycling data plot 610 for three cells fabricated using different negative active materials. Specifically, line 612 represents cycling data of a controlled cell fabricated using untreated silicon particles as described above with reference to FIG. 6A. Line 614 represents cycling data of a cell fabricated using silicon particles treated with silane. The silane treatment is explained below. Line 616 represents cycling data of a cell fabricated using silicon particles treated with poly(ethyleneimine) (PEI).

As could be seen from FIG. 6B, the cell fabricated using the PEI treated silicon particles demonstrated much longer and more stable cycle life than the cell fabricated using the untreated silicon particles (i.e., the control cell). The capacity of the cell with the PEI treated silicon particles maintained more than 90% of its initial capacity even after 80 cycles. Without being restricted to any particular theory, it is believed that PEI treatment improves adhesion between the particles and the binder resulting in more robust electrical connections to other conductive materials in the electrode and as a result to the current collector.

Line 614 displays the performance of amino-silanized silicon while line 616 that of polyamine (PEI) treated silicon. Line 612 represents the performance of a control, using untreated silicon. For the poly(amine) adsorption, 40 g of silicon particles were mixed with 80 mL of a poly(ethyleneimine) (PEI) solution. The solution included 0.2% of PEI (Sigma Aldrich, Part #181978; MW˜750,000) in water (pH 9-10, paper). The mixture was placed into a polyethylene bottle and shaken using Burrell Wrist Action Shaker for about 9 hours. About 5 g of that dispersion was removed for other experiments. The remainder was centrifuged at 11,000 rpm for 15 min using Eppendorf #5804 tubes to give a cake and a clear supernatant of pH˜9. The cake was freed of adherent PEI solvent by re-dispersion in water followed by centrifugation. The process was repeated two times when the pH of the supernatant was the same as that of water (˜7). The cake was transferred to a poly(ethylene) bottle and re-dispersed in ˜80 mL of water. To that dispersion was added 17.92 g of graphite (CGP G5) and 1.28 g of carbon black (Super P). The mixture was agitated using Burrell Wrist Action Shaker for about 2 hours and then centrifuged at 11,000 rpm for 15 min. The supernatant was decanted and the cake was dispersed in ˜80 mL of 0.01% PEI solvent and shaken using Burrell Wrist Action Shaker for 1 hour followed by centrifugation at 11,000 rpm for 15 min and decantation of the supernatant. The supernatant had a slight “sheen” on top believed to be graphite. Its amount was estimated to be <50 mg. The cake was re-dispersed one more time in 0.01% PEI solution and centrifuged. A part of the wet cake in the centrifuge tubes was transferred to a Petri dish, while some was left in the tubes. The product in both the Petri dish and the tubes was dried at room temperature at low pressure created by an oil vacuum pump vacuum for 2 hour and then at 70° C. vacuum overnight. The dry product was a fluffy gray powder, which was transferred to a polyethylene jar. The powder in the polyethylene jar was shaken using Burrell Wrist Action Shaker for 3 hours to break up aggregates. 53 g of product was recovered.

### Preparative Methods and Analyses

### Example 3

### Preparation of Surface-Bound (3-Aminopropyl)Trimethoxysilane and N-[3-(Trimethoxysilyl)Propyl]Aniline

The alkoxysilanes required pre-hydrolysis. This was performed by stirring 5 g of the silane in a 95:5 mixture of methanol:water which had been pH adjusted to 4.5-5.5 using acetic acid prior to silane addition. This was left for 30 minutes to ensure a full hydrolysis of the silane. This solution of hydrolyzed silane was added to 25 g of silicon particles (Elkem Silgrain™ Metallurgical Grade Silicon; D50 of 4.1 μm (D10=2.1 μm, D90=7.4 μm) and BET of approximately 2) and left to reflux for 1 hour. After this reflux period the condenser was removed and the contents were reduced to half volume. 150 ml of xylene was then added and left to reflux for approx 19 hours. The subsequent material was then filtered and washed with methanol. It was dried under vacuum prior to overnight drying in an atmospheric oven

### Example 4

### Preparation of Surface-Bound Silquest™ Silicon Particles

3.4 mL H2O and 0.34 mL EtOH are mixed together and 0.152 mL Silquest™ Y-15744® (Momentive Performance Materials Inc) is added. The pH (˜10) is adjusted to 5 by addition of neat acetic acid (50 uL). This is allowed to rest for 5 min to form any hydrolysis products required. This liquid is poured onto 20 g silicon particles (Elkem Silgrain™ Metallurgical Grade Silicon; D50 of 4.1 μm (D10=2.1 μm, D90=7.4 μm) and BET of approximately 2) and the slightly damp solid stirred and allowed to rest for 2 hr at room temperature. This is then heated to 60° C. for 2 hr on a temperature controlled hot plate (in a RBF), and then transferred to an oven at 100° C. for a further 1 hr. The material was analysed by FTIR and concluded that amine containing products were present. C, N, O and S have also been observed by LECO (0.28%, 0.048%, 0.82% and 0.004% [mass percent] respectively).

### Example 5

### Subtractively Normalised FTIR Spectroscopy of Cells Including an Electrode Comprising Silquest Treated and Untreated 5 μm Silicon Particles

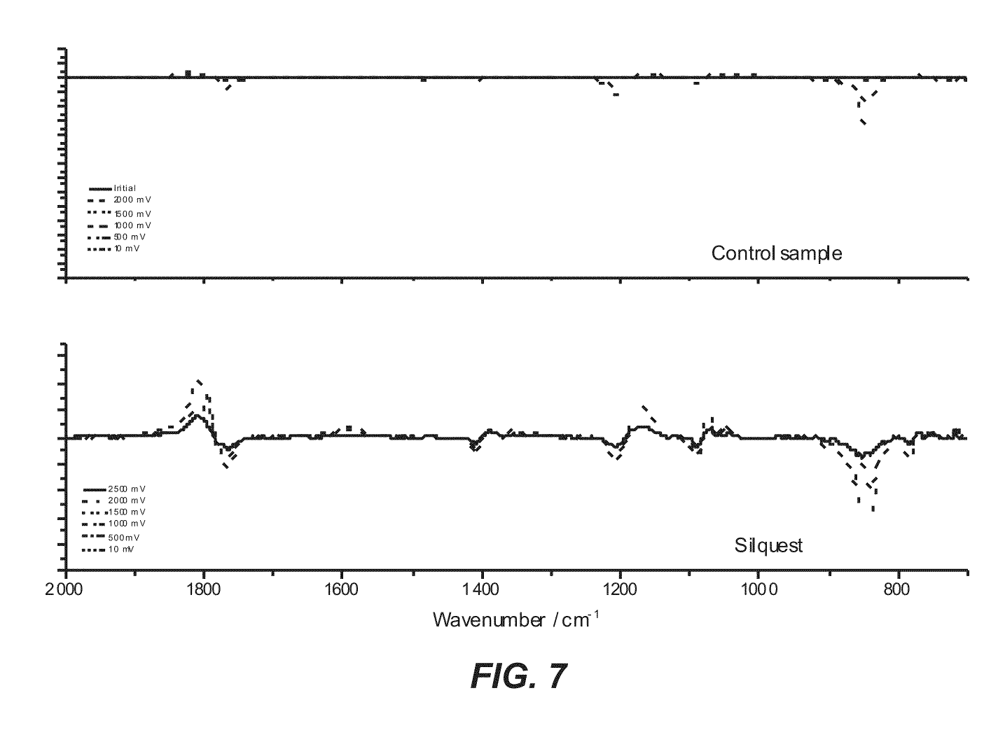

The FTIR spectrum of half cells comprising Silquest™ treated silicon 5 μm particles and half cells comprising untreated 5 μm silicon particles was carried out using subtractively normalized FTIR spectroscopy. Half cells comprising an anode comprising 10 wt % silicon material (Silgrain™ Metallurgical Grade Silicon; D50 of 4.1 μm (D10=2.1 μm, D90=7.4 μm) and BET of approximately 2), 75 wt % graphite (SFG6) and a polyacrylic acid binder (PAA), a lithium metal cathode and an electrolyte comprising 1:1 EC:PC and 1M LiPF₆ as an additive were scanned between wave numbers of 800 and 2000 cm-1 at voltages of 10 mV, 500 mV, 1000 mV, 1500 mV, 2000 mV and 2500 mV. In all cases the potentials were held for 2 minutes to allow an equilibrium to establish and the cells were scanned their respective potential at a rate of 50 mVs-1. The results are illustrated in FIG. 7.

FIG. 7a illustrates the substractively normalized FTIR spectrum for an electrode material comprising 10 wt % 5 μm untreated silicon particles, 75 wt % graphite (SFG6) and 15 wt % of a polyacrylic acid binder. It can be seen that the cell is characterized by the loss of species carboxylic acid moieties at around 1800 cm-1 and 1400 cm-1. There also appears to be a loss of some carbon to carbon bonds at around 1100 cm-1. This loss of species may be due to the formation of an SEI layer at the surface of the silicon particle.

FIG. 7b illustrates the substractively normalized FTIR spectrum for an electrode material comprising 10 wt % 5 μm silquest treated silicon particles, 75 wt % graphite (SFG6) and 15 wt % of a polymeric (PAA) binder. It can be seen that the trace is quite different from that obtained for the control sample of FIG. 1a and is characterized by the creation of amide bonds at around 1800 cm-1 and 1600 cm-1 in particular.

It would therefore appear that an electrode material comprising Silquest™ treated silicon particles and polyacrylic acid is characterized by the formation of amide bonds as a result of a reaction between the amine group of the silicon bound Silquest™ material and the polyacrylic acid binder. This bonding enhances the cohesion of the electrode material.

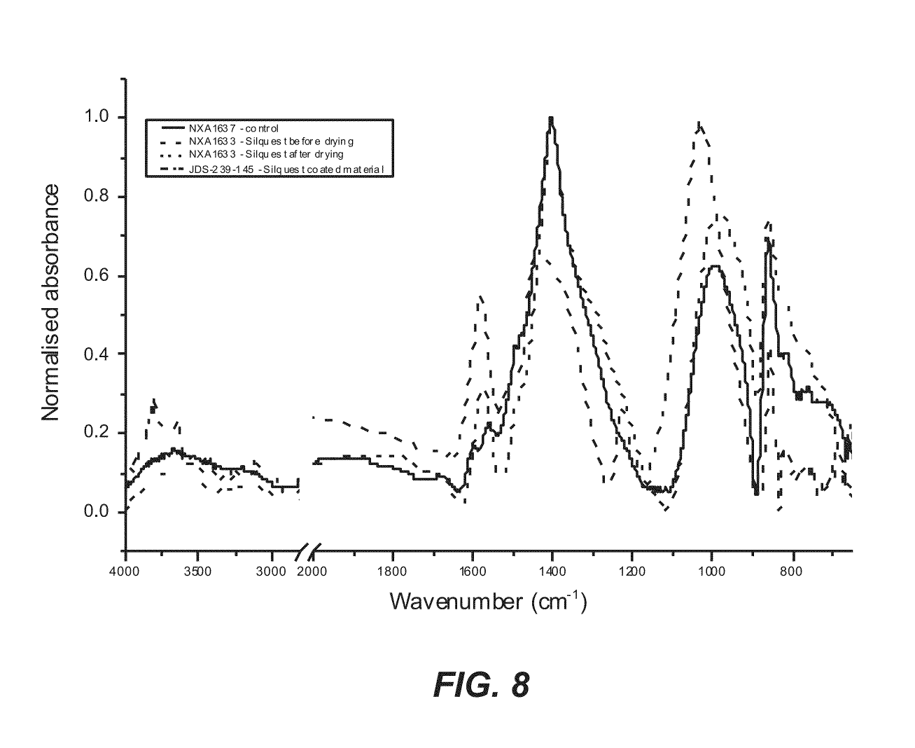

These observations are further supported by FTIR spectrum (FIG. 8) generated for half cells comprising an anode comprising 10 wt % silicon material (Silgrain Metallurgical Grade Silicon; D50 of 4.1 μm (D10=2.1 μm, D90=7.4 μm) and BET of approximately 2), 75 wt % graphite (SFG6) and a polyacrylic acid binder (PAA), a lithium metal cathode and an electrolyte comprising 1:1 EC:PC and 1M LiPF6 as an additive. Half cells comprising anodes comprising Silquest™ coated and uncoated (control) silicon particles and a lithium cathode are prepared. It can be seen that the carbonyl absorptions attributed to carbonyl groups at 1400 cm-1 that are present in the uncoated control sample are significantly diminished in the Silquest™ coated sample and are replaced by the emergence of adsorption bands corresponding to amide groups at 1570 cm-1.

### Example 6

### Electrochemical Impedance Spectroscopy

Half cells comprising an anode comprising 10 wt % silicon material (Silgrain Metallurgical Grade Silicon; D50 of 4.1 μm (D10=2.1 μm, D90=7.4 μm) and BET of approximately 2), 75 wt % graphite (SFG6) and a polyacrylic acid binder (PAA), a lithium metal cathode and an electrolyte comprising 1:1 EC:PC and 1M LiPF6 as an additive were prepared according to Examples 4 and 5 above and investigated using electrochemical impedance spectroscopy (EIS).

Electrochemical Impedance Spectroscopy (EIS), measures the dielectric properties of a component as a function of applied frequency. It often used experimentally to characterize electrochemical systems. This technique measures the impedance of a system over a range of frequencies. Impedance is the opposition of a system to the flow of alternating current (AC) in a complex system. Electrochemical cells comprise both resistive and energy storage (capacitive) elements. EIS can be used to measure the contribution of both the resistive and capacitive components of a system to its impedance.

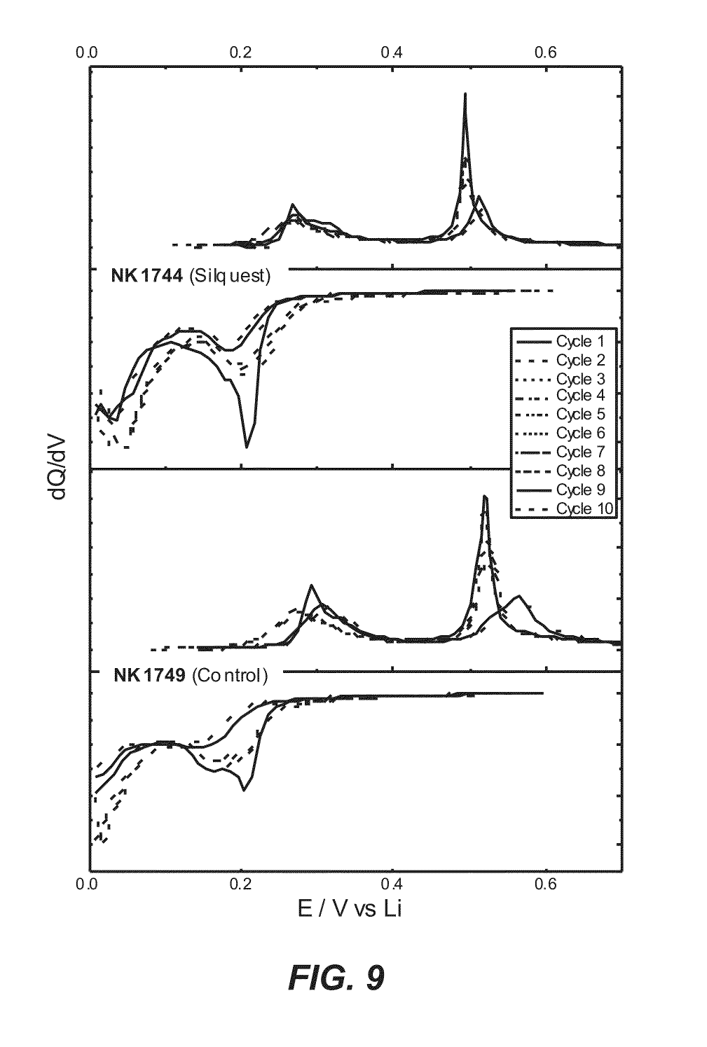

The results of EIS are interpreted using an equivalent circuit model such as that illustrated in FIG. 9. The equivalent circuit models are used to determine the contributions made by the resistive, capacitive and impedance component of the electrochemical cell. The EIS trace is obtained by scanning between 100 kHz and 100 mHz with 71 data points and a sinus amplitude of 5 mV centred at 0 V vs OCV. The scan was performed using a VMP3 potentiostat supplied by Bio Logic.

The results are set out in Table 1 below.

TABLE 1

| | SilquestTM | | | |
|---|---|---|---|---|
| | Coat | Control- | SilquestTM - | Control - |
| R3 | formation | formation | 10 cycles | 10 cycles |
| FCL | 11.18 | 10.94 | | |
| OCV after | 0.02492 | 0.03047 | | |
| lithiation | | | | |
| OCV after | 0.68212 | 0.72508 | | |
| delithiation | | | | |
| R1 | 25.53 | 28.1 | 4.588 | 11.43 |
| W1 | 15.7 | 15.96 | 4.738 | 6.44 |
| Q1 | 0.00321 | 0.00448 | 0.0004316 | 0.000865 |
| a1 | 0.7903 | 0.6369 | 0.8672 | 0.6329 |
| R2 | 9.117 | 14.73 | 2.366 | 13.91 |
| | 18.19 | 8.764 | 22.03 | 8.775 |
| Q3 | 0.000831 | 0.0003508 | 0.0000411 | 0.0001692 |
| a3 | 0.6149 | 0.6279 | 0.3479 | 0.57 |

It can be seen that the capacity Q1 of the electrode material comprising Silquest™ treated silicon particles is significantly less than the capacity of the control. This suggests that the SEI at the surface of the Silquest™ treated silicon is thinner than the SEI formed at the surface of the silicon in the control sample. Further, it appears that the exponent (al) is higher for the electrode material comprising Silquest™ treated silicon particles compared to the control. This implies that the SEI formed on the surface of the Silquest™ material is smoother and/or more flexible than the SEI layer formed at the surface of the control.

dQ/dV vs E/V Plots

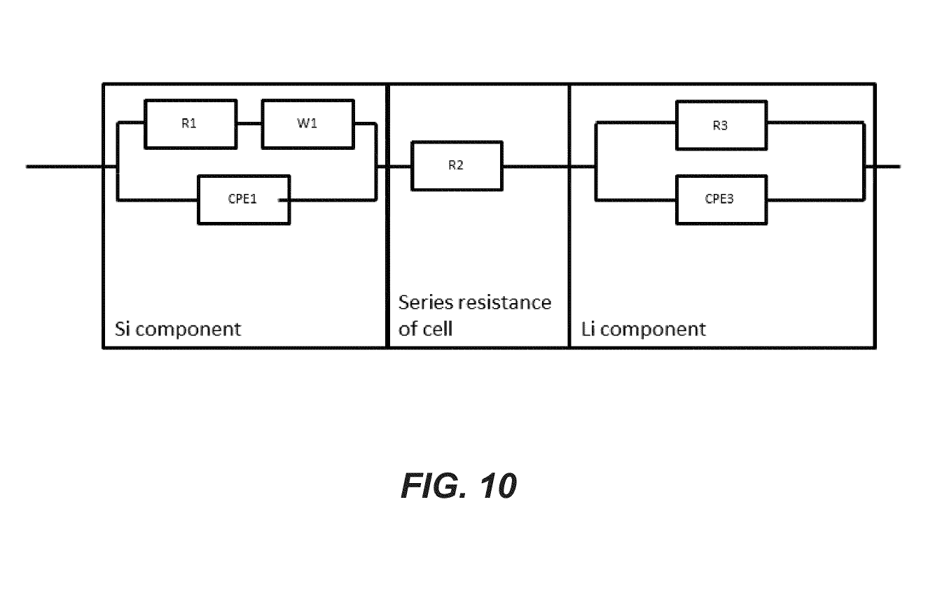

dQ/dV vs voltage plots for electrode materials comprising Silquest™ treated or untreated (control) silicon particles prepared as described in Examples 4 and 5 are established and are illustrated in FIG. 10. From FIG. 10a it can be seen that electrode materials comprising Silquest™ treated silicon particles are characterised by a voltage peak at around 0.2V, which corresponds to lithiation of silicon and another peak at 0.025V, which corresponds to the lithiation of graphite. Delithiation of graphite takes place at around 0.275V and delithiation of silicon takes place at around 0.5V. The voltages at which lithiation and delithiation take place remain fairly constant over 10 cycles for the Silquest™ treated material.

In contrast, for the control material (illustrated in FIG. 10b) the lithiation voltage for the silicon component of the electrode material drifts from 0.2V for the first cycle to 0.14V for the tenth cycle. A similar drift in voltage is observed for the lithiation of the graphite component of the electrode material. The voltage at which delithiation takes place drifts from 0.3V for the graphite component to 0.35V over 10 cycles. For the silicon component there is a greater change in the voltage at which delithiation takes place, changing from 0.52V in the first cycle to 0.59 volts in the tenth cycle.

The voltage changes observed for the control material indicate that the resistance of the control material increases as the number of cycles increases. This does not happen with the Silquest™ treated material, which suggests that the electrode material containing the Silquest coated silicon particles is characterised by a thinner and more stable SEI layer compared to the untreated control material.

Electrode materials comprising aminosilane treated silicon particles and a binder including a functional group such as polyacrylic acid are therefore characterised by improved cohesion and thinner, more flexible SEI layers compared to the control materials comprising untreated silicon particles.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. An active material for use in electrochemical cells, the active material comprising a material comprising:
a structure comprising silicon, the structure comprising
a. an external surface;
b. a treatment layer covering at least a portion of the external surface of the structure comprising silicon and comprising an amine functional group;
wherein the treatment layer comprises one or more treatment materials selected from the group of formula (1):
J-(CH₂)ₘ—[[(CH₂)ₙK(CH₂)ₚ]_{q}—[O—Si(OR¹)₂₋ᵣ(R²)ᵣ—O-]ₛ]ₓ—(CH₂)ₜ—NHR³ (1)
wherein:
J is Si(OR⁴)_{2-w}(R⁵)_{w} or —NHR⁶;
K is CHR⁰ or NH;
m is an integer having a value of from 1 to 6;
n and p are each independently integers having a value of from 0 to 6;
q is an integer having a value from 0 to 30;
r is an integer having a value from 0 to 2;
s is an integer having a value from 0 to 9;
t is an integer having a value of from 1 to 6;
w is an integer having a value of from 0 to 2;
x is an integer having a value of from 0 to 15;
R⁰ is hydrogen, an amine, a C1-6 alkyl or an aminoalkyl group;
R¹ is a C₁₋₆ alkyl group;
R² is a C₁₋₆ alkyl or an aminoalkyl group;
R³ is a C₁₋₆ alkyl group
R⁴ is a C₁₋₆ alkyl group;
R⁵ is a C₁₋₆ alkyl or an aminoalkyl group;
R⁶ is H or a C₁₋₆ alkyl group.

2. The active material according to claim 1, wherein
m is an integer having a value of from 1 to 3;
n is an integer having a value of from 0 to 3;
p is an integer having a value of from 0 to 3;
q is an integer having a value of from 0 to 15;
s is an integer having a value of from 0 to 6;
t is an integer having a value of from 1 to 3; and
x is an integer having a value of from 1 to 9.

3. The active material according to claim 1, wherein the one or more treatment materials of the treatment layer comprise a poly(amine), the poly(amine) having a structure selected from the group of formula (II)
NHR⁶—(CH₂)ₘ—[(CH₂)ₙCHR⁰(CH₂)ₚ]_{q}(CH₂)ₜ—NHR³ (II)
wherein
m is an integer having a value of from 1 to 6;
n is an integer having a value of from 0 to 3;
p is an integer having a value of from 0 to 3;
q is an integer having a value of from 0 to 12;
t is an integer having a value of from 1 to 6; R⁰ is hydrogen, an amine group, a C₁₋₆ alkyl or a C₁₋₆ aminoalkyl group; an R³ and R⁶ are each independently H or a C₁₋₆ alkyl group.

4. The active material according to claim 1, wherein the one or more treatment materials of the treatment layer comprise a poly(imine), the poly(imine) having a structure selected from the group of formula (III)
NHR⁶—(CH₂)ₘ—[(CH₂)ₙNH(CH₂)ₚ]_{q}(CH₂)ₜ—NHR³ (III)
wherein
m is an integer having a value of from 1 to 6;
n is an integer having a value of from 0 to 3;
p is an integer having a value of from 0 to 3;
q is an integer having a value of from 0 to 12;
t is an integer having a value of from 1 to 6;

[symbol]

5. The active material according to claim 1, wherein R⁰ is hydrogen, an amine group, a C₁₋₆ alkyl or a C₁₋₆ aminoalkyl group.

6. The active material according to claim 1, wherein R³ and R⁶ are each independently H or a C₁₋₆ alkyl group.

7. The active material according to claim 1, wherein if q=0, then m+t≧2.

8. The active material according to claim 1, wherein if q=0, then m+t≦12.

9. The active material according to claim 1, wherein the one or more treatment materials is selected from the group consisting poly(ethyleneimine), poly(allylamine), poly(vinylamine), 1,3-diaminopropane, 1,4-diaminobutane, 1,5-diaminopentane, diethylenetriamine, triethylenetetramine, tetraethylenepentamine and pentaethylenehexamine.

10. The active material according to claim 1, wherein the treatment layer covers at least 40% of the external surface of the structure comprising silicon.

11. The active material according to claim 1, wherein the one or more treatment materials comprise a polyimine.

12. The active material according to claim 1, wherein the one or more treatment materials comprise an amino silane or an amine functionalised siloxane.

13. The active material according to claim 12, wherein the amino silane or amine functionalised siloxane is a structure selected from the group of formula (IV)
Si(OR⁴)_{2-w}(R⁵)_{w}(CH₂)ₘ[[(CH₂)ₙK(CH₂)ₚ]_{q}—[O—Si(OR¹)₂₋ᵣ(R²)ᵣ—O-]ₛ]ₓ—(CH₂)ₜ—NHR³
wherein:
K is CHR⁰ or NH;
m is an integer having a value of from 1 to 3;
n is an integer having a value of from 0 to 6;
p is an integer having a value of from 0 to 6;
q is an integer having a value of from 0 to 15;
r is an integer having a value from 0 to 2;
s is an integer having a value from 0 to 9;
t is an integer having a value of from 1 to 6;
w is an integer having a value of from 0 to 2;
x is an integer having a value of from 0 to 15;
R⁰ is hydrogen, an amine group, a C₁₋₆ alkyl or a C₁₋₆ aminoalkyl group;
R¹ is a C₁₋₆ alkyl group;
R² is a C₁₋₆ alkyl group;
R³ is H or a C₁₋₆ alkyl group
R⁴ is a C₁₋₆ alkyl group; and
R⁵ is a C₁₋₆ alkyl or an aminoalkyl group.

14. The active material according to claim 13, wherein n and p are each integers independently having a value of from 0 to 3; q is an integer having a value of from 0 to 12; s is an integer having a value of from 0 to 6; t is an integer having a value of from 1 to 3; and x is an integer having a value of from 0 to 9.

15. The active material according to claim 13, wherein q has a value of from 0 to 6.

16. The active material according to claim 13, wherein s has a value of from 0 to 3.

17. The active material according to claim 13, wherein R⁰ is hydrogen or a C₁₋₆ aminoalkyl group, or an amine terminated aminoalkyl group.

18. The active material according to claim 13, wherein R¹ is a C₁₋₃ alkyl group and R³ is preferably hydrogen.

18. The active material according to claim 13, wherein R⁴ is a C₁₋₃ alkyl group.

19. The active material according to claim 13, wherein R⁵ is a C₁₋₃ alkyl group.

20. The active material according to claim 13, wherein the amino silane is selected from the group consisting aminopropyltriethoxysilane, aminopropylmethoxysilane, bis-gamma-trimethoxysilylpropyl amine; aminoneohexyltrimethoxysilane; aminoneohexylmethoxysilane; aminoundecyltriethoxysilane; amino-2-(dimethylethoxysilyl)propane; N-(2-aminoethyl)-3-aminopropyltriethoxysilane; N-(2-aminoethyl)-3-aminopropyltrimethoxysilane; and N-(2-aminoethyl)-3-aminopropylsilanol.
